(19) United States
(12) Patent Application Publication
(10) Pub. No.: US 2026/0172624 A1
(43) Pub. Date: Jun. 18, 2026

(54) DISPLAY APPARATUS AND WINDOW PROCESSING METHOD FOR DISPLAY APPARATUS

(71) Applicant: HISENSE VISUAL TECHNOLOGY CO., LTD., Qingdao (CN)

(72) Inventors: Tao LI, Qingdao (CN); Guili JIA, Qingdao (CN); Jie FAN, Qingdao (CN); Yongyu LI, Qingdao (CN); Xiaoming SHAO, Qingdao (CN)

(21) Appl. No.: 19/531,352

(22) Filed: Feb. 5, 2026

Related U.S. Application Data
(63) Continuation of application No. PCT/CN2024/099613, filed on Jun. 17, 2024.

(30) Foreign Application Priority Data
Aug. 24, 2023 (CN) 202311074864.3
Aug. 24, 2023 (CN) 202311074873.2
Aug. 24, 2023 (CN) 202311077897.3
Aug. 24, 2023 (CN) 202311077905.4

(51) Int. Cl. H04N 21/431; H04N 21/472

(52) U.S. Cl. CPC H04N 21/4316; H04N 21/47217

(57) ABSTRACT

A display apparatus includes a display, configured to display a first page in a first window and a second page in a second window; where the first window and the second window are in a same layer, a window priority of the first window is higher than that of the second window, and the first window is in a full-screen state; at least one processor configured to execute the computer instructions to cause the display apparatus to perform: receiving a control command input by a user based on a designated entry point supported by an operating system; in response to the control command, when the first page supports the picture-in-picture mode, controlling the display to shrink a size of the first window and display the second window, where the first page is displayed in a shrunken first window and the second page is displayed in the second window.

### CROSS-REFERENCE OF RELATED APPLICATIONS

The present application is a continuation application of PCT Application No. PCT/CN2024/099613, filed on Jun. 17, 2024, which claims the priorities to Chinese Patent Application No. 202311077905.4, filed on Aug. 24, 2023, No. 202311074873.2, filed on Aug. 24, 2023, and No. 202311077897.3, filed on Aug. 24, 2023, No. 202311074864.3, filed on Aug. 24, 2023, all of which are incorporated herein by reference in their entirety.

### FIELD OF INVENTION

The present application relates to display apparatus, and particularly relates to a display apparatus and a window processing method for the display apparatus.

### BACKGROUND

Display apparatus refer to terminal devices that can output specific display images, which can be terminal devices such as smart televisions (TVs), mobile terminals, smart advertising screens, projectors, etc. Taking smart TVs as an example, smart TVs are based on Internet application technology, have open operating systems and chips, have open application platforms, can realize two-way human-computer interaction functions, and are TV products that integrate multiple functions such as audio or video, entertainment, and data to meet the diverse and personalized needs of users.

The display apparatus is configured with a picture-in-picture (PiP) mode. After the picture-in-picture mode is activated, the display apparatus displays two windows, which can include a main window and a PiP window. The main window is larger than the PiP window. The main window displays the application the user is currently using, while the PiP window displays applications that the user needs to browse simultaneously with the main application, such as video pages.

Typically, the application itself provides the entry point to active PiP mode, and users can only place the application in the PiP window through this entry point. However, the entry points provided by different applications vary in their display location and triggering methods, making it inconvenient for users to quickly active PiP mode.

### BRIEF SUMMARY

A display apparatus according to some embodiments of the present application can include: a display, configured to display a first page in a first window and a second page in a second window; where the first window and the second window can be in a same layer, a window priority of the first window can be higher than a window priority of the second window, and the first window is in a full-screen state; a memory, configured to store computer instructions and/or data associated with the display apparatus; at least one processor, connected to the display and the memory, and configured to execute the computer instructions to cause the display apparatus to perform: receiving a control command input by a user based on a designated entry point supported by an operating system, where the control command can be configured to indicate an activation of a picture-in-picture mode; in response to the control command, based on that the first page supports the picture-in-picture mode, controlling the display to shrink a size of the first window and display the second window, where the first page can be displayed in a shrunken first window and the second page can be displayed in the second window.

Embodiments of the present application provide a window processing method for a display apparatus. The display apparatus can display a first page in a first window and a second page in a second window, where the first window and the second window can be in a same layer, a window priority of the first window can be higher than a window priority of the second window, and the first window is in a full-screen state; the method can include: receiving a control command input by a user based on a designated entry point supported by an operating system, where the control command can be configured to indicate an activation of a picture-in-picture mode; in response to the control command, based on that the first page supports the picture-in-picture mode, shrinking a size of the first window and displaying the second window, where the first page can be displayed in a shrunken first window and the second page can be displayed in the second window.

### BRIEF DESCRIPTION OF THE DRAWINGS

FIG. 1 is a usage scenario of the display apparatus according to some embodiments of the present application.

FIG. 2 is a configuration block diagram of the control device according to some embodiments of the present application.

FIG. 3 is a configuration diagram of the display apparatus according to some embodiments of the present application.

FIG. 4 is an operating system configuration diagram of a display apparatus according to some embodiments of the present application.

FIG. 5A is a schematic diagram of the system architecture related to activating PiP mode in the operating system of the display apparatus according to some embodiments of the present application.

FIG. 5B is a schematic diagram of the system architecture related to the display of PiP windows in the operating system of the display apparatus according to some embodiments of the present application.

FIG. 5C is a schematic diagram of the system architecture related to the playback control of video within the PiP window in the operating system of the display apparatus according to some embodiments of the present application.

FIG. 5D is a schematic diagram of the system architecture related to multi-window mode in the operating system of the display apparatus according to some embodiments of the present application.

FIG. 6 is a flowchart of activating PiP mode on a display apparatus according to some embodiments of the present application.

FIG. 7 is a flowchart of activating PiP mode on a display apparatus according to some embodiments of the present application.

FIG. 8 is a flowchart of a display apparatus identifying whether the first page supports PiP mode according to some embodiments of the present application.

FIG. 9 is an interactive schematic diagram of a display apparatus activating PiP mode according to some embodiments of the present application.

FIG. 10 is an interactive schematic diagram of a display apparatus activating PiP mode according to some embodiments of the present application.

FIG. 11 is an interactive schematic diagram of a display apparatus activating PiP mode according to some embodiments of the present application.

FIG. 12 is an interactive schematic diagram of a display apparatus activating PiP mode according to some embodiments of the present application.

FIG. 13 is a flowchart of activating PiP mode on a display apparatus according to some embodiments of the present application.

FIG. 14 is an interactive schematic diagram of a display apparatus switching to display a page in PiP mode according to some embodiments of the present application.

FIG. 15 is an interactive schematic diagram of a display apparatus switching to display a page in PiP mode according to some embodiments of the present application.

FIG. 16 is a flowchart of a display apparatus displaying a PiP window according to some embodiments of the present application.

FIG. 17 is a flowchart of a display apparatus shrinking a first window according to some embodiments of the present application.

FIG. 18 is a flowchart of displaying the PiP window when the display apparatus enters PiP mode according to some embodiments of the present application.

FIG. 19 is an interactive schematic diagram of displaying the PiP window when the display apparatus enters PiP mode according to some embodiments of the present application.

FIG. 20 is a flowchart of the display apparatus showing the PiP window after switching according to some embodiments of the present application.

FIG. 21 is an interactive schematic diagram of the display apparatus showing the PiP window after switching according to some embodiments of the present application.

FIG. 22 is a flowchart of a display apparatus adjusting the size of the PiP window according to some embodiments of the present application.

FIG. 23 is a flowchart of a display apparatus adjusting the size of the PiP window according to some embodiments of the present application.

FIG. 24 is a flowchart of a display apparatus adjusting the size of the PiP window according to some embodiments of the present application.

FIG. 25 is a flowchart of a display apparatus adjusting the PiP window according to some embodiments of the present application.

FIG. 26 is an interactive schematic diagram of a display apparatus adjusting the PiP window according to some embodiments of the present application.

FIG. 27 is an interactive schematic diagram of a display apparatus adjusting the PiP window according to some embodiments of the present application.

FIG. 28 is a schematic diagram of the PiP menu according to some embodiments of the present application.

FIG. 29 is a flowchart of a display apparatus displaying a PiP window according to some embodiments of the present application.

FIG. 30 is a flowchart of a display apparatus displaying playback control keys according to some embodiments of the present application.

FIG. 31 is a flowchart illustrating the display apparatus identifying whether the first page is a video page according to some embodiments of the present application.

FIG. 32 is a flowchart illustrating the display apparatus obtaining the package name of a first application according to some embodiments of the present application.

FIG. 33 is a flowchart of a display apparatus obtaining information about a top-level PiP application according to some embodiments of the present application.

FIG. 34 is a flowchart of a display apparatus displaying a playback control menu according to some embodiments of the present application.

FIG. 35 is a flowchart illustrating different playback control keys displayed on a display apparatus according to some embodiments of the present application.

FIG. 36 is an interactive schematic diagram of a display apparatus displaying a PiP window according to some embodiments of the present application.

FIG. 37 is an interactive schematic diagram of a display apparatus displaying a PiP window according to some embodiments of the present application.

FIG. 38 is a flowchart of a display apparatus implementing video playback control based on playback control keys according to some embodiments of the present application.

FIG. 39 is a flowchart of a display apparatus controlling video playback according to some embodiments of the present application.

FIG. 40 is an interactive schematic diagram of the display apparatus updating playback control keys according to some embodiments of the present application.

FIG. 41 is a flowchart of the display apparatus updating playback control keys according to some embodiments of the present application.

FIG. 42 is a flowchart of a display apparatus switching multi-window mode according to some embodiments of the present application.

FIG. 43 is a flowchart of a display apparatus entering a first multi-window mode according to some embodiments of the present application.

FIG. 44 is a flowchart of a display apparatus controlling an application within a first window according to some embodiments of the present application.

FIG. 45 is a flowchart of a display apparatus switching back from a second multi-window mode to a first multi-window mode according to some embodiments of the present application.

FIG. 46 is a flowchart of a display apparatus switching multi-window mode according to some embodiments of the present application.

FIG. 47 is an interactive schematic diagram of a display apparatus switching multi-window mode according to some embodiments of the present application.

FIG. 48 is a flowchart of a display apparatus entering a second multi-window mode according to some embodiments of the present application.

FIG. 49 is an interactive schematic diagram of a display apparatus switching multi-window mode according to some embodiments of the present application.

### DETAILED DESCRIPTION OF THE EMBODIMENTS

The following embodiments are described in detail, and examples thereof are shown in the accompanying drawings. When the following description refers to the drawings, unless otherwise indicated, the same numbers in different drawings represent the same or similar elements. The implementations described in the following embodiments do not represent all implementations consistent with the present application. They are only examples of systems and methods consistent with some aspects of the present application as detailed in the claims.

It should be noted that the brief description of terms in the present application is only for the convenience of understanding the embodiments described below, and is not intended to limit the embodiments of the present application. Unless otherwise specified, these terms should be understood according to their common and usual meanings.

The terms “first”, “second”, “third”, etc., in the specification and claims of the present application and the above drawings are used to distinguish similar or similar objects or entities, and do not necessarily mean to limit a specific order or sequence, unless otherwise noted. It should be understood that the terms used in this way can be interchangeable under appropriate circumstances.

The terms “comprise”, “include”, and “having”, and any variations thereof, are intended to cover but not exclude inclusion, for example, a product or device comprising a list of components is not necessarily limited to all the components expressly listed but can include other components not expressly listed or inherent to such product or device.

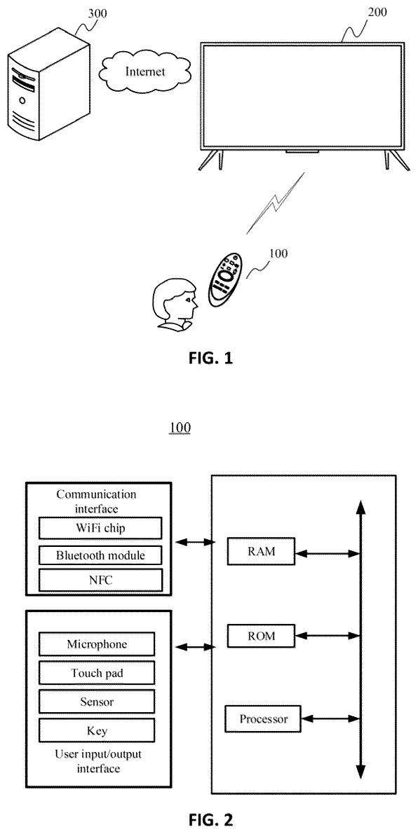

The display apparatus provided in embodiments of the present application can have various implementation forms, such as a smart TV, laser projection device, monitor, electronic bulletin board, electronic table, etc., or a device with a display screen such as a mobile phone, tablet computer, or smart watch, etc. FIG. 1 and FIG. 2 are a specific implementation of the display apparatus of the present application.

FIG. 1 is a schematic diagram of a usage scenario of a display apparatus according to some embodiments of the present application. As shown in FIG. 1, a user can operate a display apparatus 200 through a control device 100, and the display apparatus 200 can obtain network data through a server 300, or obtain a live broadcast signal through a satellite.

FIG. 2 is a block diagram of a configuration of a control device 100 according to some embodiments of the present application. In some embodiments, the control device 100 can be a remote controller, and the communication between the remote controller and the display apparatus 200 can include at least one of infrared protocol communication, or Bluetooth protocol communication, or other short-range communication manners, to control the display apparatus 200 wirelessly or wired. The user may input user commands through keys on the remote controller, voice input, control panel input, etc., to control the display apparatus 200.

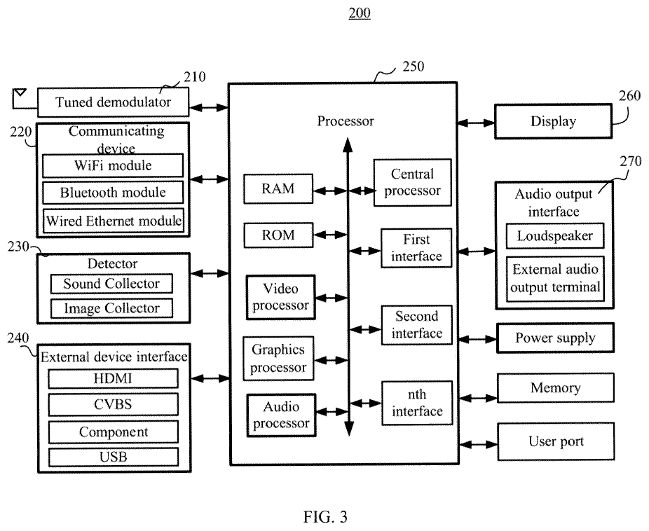

FIG. 3 is a configuration block diagram of a display apparatus 200 according to some embodiments of the present application. As shown in FIG. 3, the display apparatus 200 can include at least one of a tuning demodulator 210, a communicator 220, a detector 230, an external apparatus interface 240, at least one processor 250, a display 260, an audio output interface 270, a memory, a power supply, or a user interface 280.

In some embodiments, the display apparatus 200 can establish the transmission and reception of control signals and data signals with the control device 100 or the server 300 through the communicator 220.

In some embodiments, the detector 230 can include a sound collector. The display apparatus 200 can collect user voice through a sound collector and transmit the collected user voice to at least one processor 250 for processing.

In some embodiments, at least one processor 250 and tuning demodulator 210 can be located in different separate devices, that is, the tuning demodulator 210 can be located in an external device of the main device where at least one processor 250 is located, such as an external set-top box. In some embodiments, at least one processor 250 can control the operation of the display apparatus and respond to user operations through various software control programs/computer instructions stored in the memory. At least one processor 250 can control the overall operation of the display apparatus 200. In some embodiments, at least one processor 250 can include at least one of a central processing unit (CPU), a video processor, an audio processor, a graphics processing unit (GPU), a random access memory (RAM), a read-only memory (ROM), a first to an nth interface for input/output, a communication bus, etc.

In some embodiments, the display 260 can include a display screen component for presenting pages; a driving component for driving image display, for receiving image signals output from at least one processor 250, and for displaying video content, image content; menu control interface components, and user control UI interface components. In some embodiments, the display 260 can be a liquid crystal display, an organic light-emitting diode (OLED) display, or a projection display, and can also be a projection device and a projection screen. In some embodiments, a user can input user commands through a graphical user interface (GUI) displayed on a display 260, and the user input interface receives user input commands through the graphical user interface (GUI). Alternatively, users can input user commands by entering specific sounds or gestures. The user input interface then uses sensors to recognize the sounds or gestures to receive the user input commands.

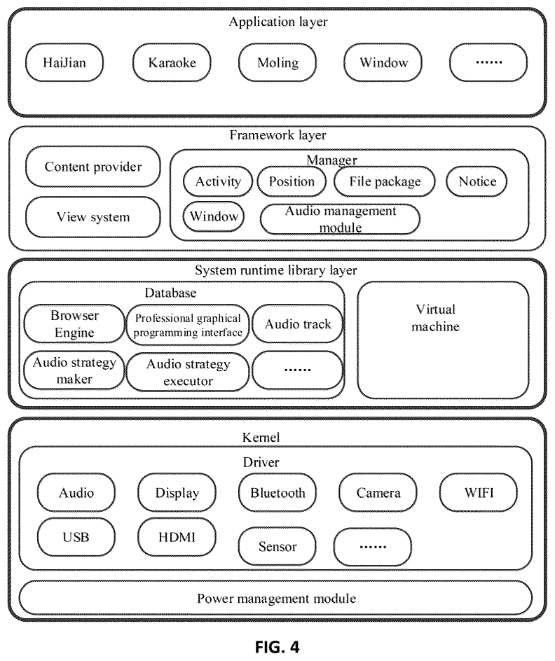

Referring to FIG. 4, in some embodiments, the operating system of the display apparatus 200 can be divided into four layers, which are respectively the application layer (hereinafter referred to as the “application layer”), the application framework layer (hereinafter referred to as the “framework layer”), the Android runtime and the system library layer (hereinafter referred to as the “system runtime library layer”), and the kernel layer from top to bottom. In some embodiments, at least one application can be run in the application layer, and these applications can be window programs, system setting programs, or clock programs that come with the operating system, such as live broadcast applications, which can be configured to play live programs; or they can be applications developed by third-party developers.

The display apparatus can be configured with a picture-in-picture (PiP) mode. After PiP mode is activated, the display apparatus can display two windows, which can include a main window and a PiP window. The PiP window can be displayed on top of the main window, the main window is in full-screen state. The size of the PiP window can be smaller than the size of the main window. The main window can be configured to display the application that the user is currently using. The PiP window can be configured to display the page of the application that the user needs to browse at the same time as the main application. This page can be the complete page of the application or a part of the application. If the page is a part of the application, then the part of the page can include the main content of the complete page. For example, the PiP window can display the complete video page of a video application, or it can display video frames within the video page.

Typically, the application itself provides the entry point to active PiP mode, and the application itself can call the PiP mode interface to enter PiP mode. For example, the operating system can provide an interface for applications to enter PiP mode, such as enterPictureInPictureMode, and allow applications to customize scenes to switch the page to be displayed in the PiP window. Applications typically provide an entry point for activating PiP mode within the pages of application, based on the page design by the developer. If the user wants to active PiP mode and switches the page of the current application to be displayed in the PiP window, the user needs to find the entry point for activating PiP mode provided by the application and inputs the command based on that entry point. In response to this command, the application declares the current page as supporting PiP mode, such as setting android:supportsPictureInPicture to true for the corresponding page (Activity) in the application manifest file. The application will call the system-provided enterPictureInPictureMode interface in a custom scenario to switch the Activity to be displayed in the PiP window, thereby activating PiP mode. As can be seen, users can only place the page of the application in the PiP window through the entry point provided by the application, and the application can only control its own page to enter PiP mode.

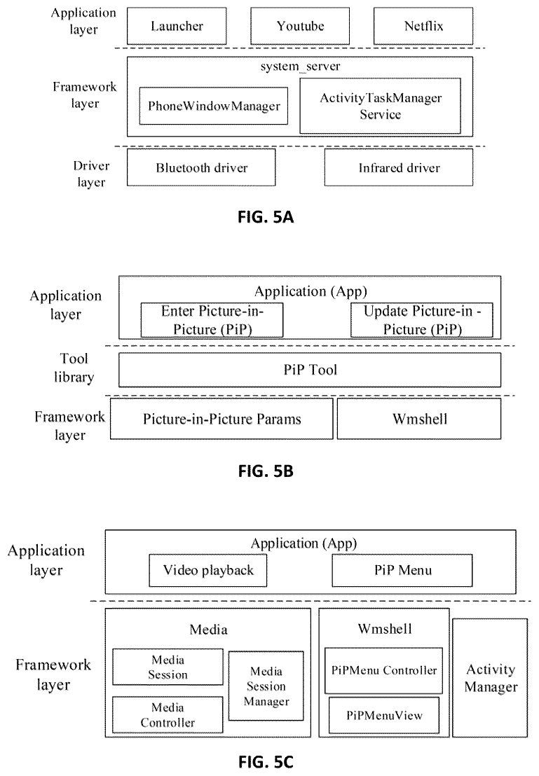

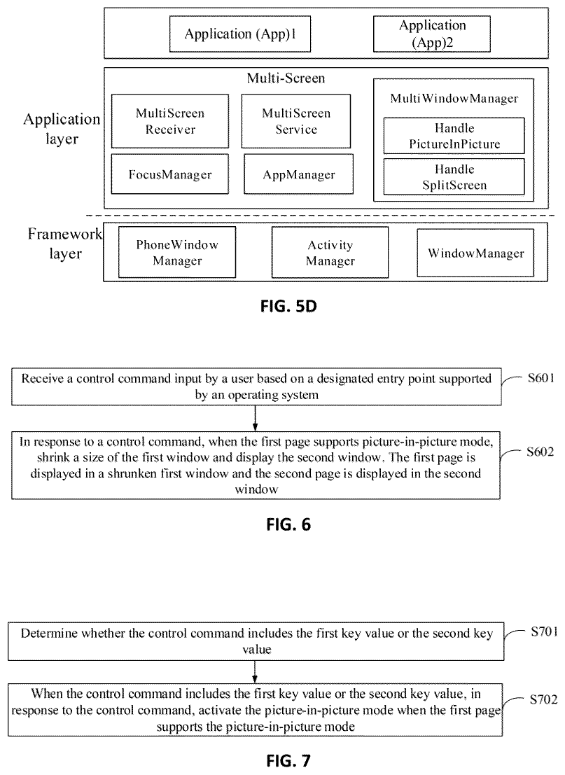

Due to the requirement that PiP mode must be activated by the application itself, users can only enter PiP mode through the entry point provided by the application. However, the entry points provided by different applications vary in their display location and triggering methods, making it inconvenient for users to quickly active PiP mode. The display apparatus according to some embodiments of the present application can provide a unified entry point supported by the operating system for various applications to enter PiP mode. FIG. 5A is a schematic diagram of the system architecture related to activating PiP mode in the operating system of the display apparatus according to some embodiments of the present application. As shown in FIG. 5A, the system architecture related to activating PiP mode mainly involves the application layer, the framework layer, and the driver layer. The driver layer can include Bluetooth driver and infrared driver. The system services (system_server) in the framework layer can include the PhoneWindowManager class for managing phone windows and the ActivityTaskManagerService for managing page tasks. The application layer can include various applications, such as launchers, YouTube, Netflix, etc.

Based on the system architecture shown in FIG. 5A, the display apparatus can configure a designated entry point supported by the operating system for each application to active PiP mode. This designated entry point can include a first key on the control device (such as the PiP key), a second key on the virtual keyboard of the display apparatus (such as the PiP key), or a first entry point in the system menu. The first key corresponds to the first key value, such as PiP, and the second key corresponds to the second key value, such as PiP. The first key value and the second key value correspond to activation mode. In some embodiments, the system menu can be a shortcut menu. This designated entry point is independent of the application itself and is not affected by the application itself. Therefore, this designated entry point is the unified entry point for all applications to active PiP mode.

FIG. 5B is a schematic diagram of the system architecture related to the display of PiP windows in the operating system of the display apparatus according to some embodiments of the present application. As shown in FIG. 5B, the system architecture related to the display of PiP windows mainly involves the application layer, tool library and framework layer. The application layer can include applications that active PiP mode, such as the designated entry points supported by the operating system configured for each application activation mode in the system architecture shown in FIG. 5A. The tool library can include PiP tools, the PiP tools are a layer of encapsulation for applications to enter PiP mode and serve as a bridge connecting the application layer and the framework layer. The framework layer can include the PiP parameters (Picture-in-Picture Params) class and the Window Manager Shell (Wmshell). Wmshell can provide a toolkit for more efficient window management. Wmshell can be located in the framework/base/libs/WindowManager directory. Wmshell can provide various window management toolkits, such as the PiP sub-package, SplitScreen sub-package, FreeForm sub-package, Compatibility User Interface (CompatUI), and desktop mode, etc.

Based on the system architecture shown in FIG. 5B, some embodiments of the present application customize the PiP parameter class, PiP tools, and Wmshell (details are provided below). Among them, the width and height dimensions (hereinafter referred to as width and height) attribute and corresponding methods for setting the attributes are added to the PiP parameter class. Thus, when the current page enters PiP mode, the required image size for display within the PiP window can be passed to the PiP parameter class. Provides methods for setting the size of the PiP window for the PiP tool, allowing the application to pass the image size of the PiP parameter class to Wmshell. Wmshell can be customized to draw PiP windows based on the image size passed in by the PiP tool.

FIG. 5C is a schematic diagram of the system architecture related to the playback control of video in the PiP window in the operating system of the display apparatus according to some embodiments of the present application. As shown in FIG. 5C, the system architecture related to the playback control of video in the display PiP window mainly involves the application layer and the framework layer. The application layer can include applications displayed in PiP mode, and video playback, displaying playback control menus, etc., can be implemented at the application layer. Applications displayed in PiP windows can be implemented in the system architecture shown in FIG. 5B by customizing the PiP parameter class, PiP tools, and Wmshell, allowing the PiP window to be drawn according to the image size. Based on the system architecture shown in FIG. 5B, the framework layer in the system architecture shown in FIG. 5C can also include A media (Media) and an activity manager (ActivityManager). Media can include a media session (MediaSession), a media controller (MediaController), and a media session manager (MediaSessionManager). MediaSessionManager can query all currently active MediaController in the system and provide support for interaction with MediaSession. MediaSession can provide support for interaction with MediaController, which can implement playback control of audio and video, such as play, pause, stop, fast forward and rewind. Wmshell can further include a PiP menu controller (PiPMenuController) and a PiP menu view (PiPMenuView). In some embodiments, the Wmshell component can customize the menu functionality of PiP, displaying the corresponding playback control menu when a video is played within the PiP window. ActivityManager can be configured to manage PiP windows and interact with Wmshell for playback control.

FIG. 5D is a schematic diagram of the system architecture related to multi-window mode in the operating system of the display apparatus according to some embodiments of the present application. As shown in FIG. 5D, the system architecture related to multi-window mode mainly involves the application layer and the framework layer. The application layer can include applications that support multi-window mode, such as App 1 and App 2, for example, applications that support PiP mode and applications that support split-screen mode.

The application layer can further include a multi-screen (MultiScreen) module, which can be configured to implement the core function of switching between multiple window modes. It can include a multi-screen receiver (MultiScreenReceiver), a multi-screen service (MultiScreenService), a focus manager (FocusManager), an application manager (AppManager), and a multi-window manager (MultiWindowManager). The multi-screen receiver can be configured to receive control commands indicating multi-window mode and to start the foreground multi-screen service. Multi-screen service is a core service. After receiving a broadcast from the multi-screen receiver, the multi-screen service can determine the current working mode of the application, such as multi-window mode or non-multi-window mode. Since the multi-window mode is activated through the multi-screen service, the multi-screen service itself can save the current multi-window mode of the application. Multi-window mode can include the aforementioned PiP mode and split-screen mode. Multi-screen services can trigger the next working mode based on the current working mode of the application. The focus manager is a manager that can be configured to manage window focus. By obtaining page information (Activity info), the focus manager can control the window focus in split-screen mode. The application manager can be configured to manage applications that support split-screen mode. The application manager can obtain page information, such as stack, activity, etc. The multi-window manager is the main manager for managing multiple windows, and can be configured to switch between PiP mode and split-screen mode.

The framework layer can include a phone window manager (PhoneWindowManager), an activity manager (ActivityManager), and a window manager (WindowManager). Among them, the phone window manager can be configured to receive control commands that indicate multi-window mode, such as split-screen keys, and convert them into broadcasts to send to multi-screen receivers in multiple screens. The activity manager is a system manager class used to manage activities. Through this class, the application manager can obtain relevant information about App 1 and App 2 that support split-screen, such as package name, activity, activity stack, etc. The window manager can be configured to manage application windows. Switching between windows in PiP mode and split-screen mode is controlled and handled through the window manager.

After introducing the system architecture of the display apparatus in some embodiments of the present application, the following describes the flow of a window processing method for a display apparatus in some embodiments of the present application with reference to the accompanying drawings. The method mainly involves activation PiP mode. Through this method, users can quickly active PiP mode based on the unified entry point provided by the display apparatus and display the current page in PiP mode.

In some embodiments, the display apparatus is not in the PiP mode. The display apparatus has created a first window and a second window, and displays the first page in the first window and the second page in the second window. The first window and the second window are in the same layer. The window priority of the first window is higher than the window priority of the second window. The first window is in full-screen state. Therefore, the display apparatus prioritizes displaying the first page in the first window. In this state, users can only watch the first page and cannot watch the second page.

The process of creating multiple windows on a display apparatus can be illustrated with the following embodiments.

In some embodiments, based on the system architecture shown in FIG. 5A, when the display apparatus displays a Launcher page, the Launcher page can include video options. If the user inputs a control command based on the video option, the display apparatus can respond to the control command by playing the video. The video playback page is the first page, and the window containing the video playback page is the first window; the Launcher page is the second page, and the window containing the Launcher page is the second window. The video playback page is displayed above the Launcher page, allowing users to watch the video playback page but not the Launcher page located below.

In some embodiments, still based on the system architecture shown in FIG. 5A, when the display apparatus displays the Launcher page, the Launcher page can include video application options. If the user inputs a control command based on the video application options, the display apparatus can respond to the control command and enter the video application page, which can include video options. If the user enters a control command based on the video option, the display apparatus can respond to the control command to play the video. The video playback page is the first page, and the window containing the video playback page is the first window; the video application page is the second page, and the window containing the video application page is the second window. The video playback page is displayed above the video application page, while the Launcher page is located at the lowest level. Therefore, the Launcher page is displayed below the video application page. At this point, users can watch the video but cannot watch the video application page and Launcher page located below.

In some embodiments, the second window can also be in full-screen state.

The display apparatus can active PiP mode according to the process shown in FIG. 6. The specific steps can include, but are not limited to, the following operations.

S601, receive a control command input by a user based on a designated entry point supported by an operating system.

The control command can be configured to indicate the activation of PiP mode.

In some embodiments, a user can input the control command to the display apparatus by pressing a first key on the control device.

In some embodiments, a user can input commands to a display apparatus through a control device to cause the display apparatus to display a virtual keyboard, which can include a second key. Users can control the focus to move to the second key on the virtual keyboard using the control device, and can input control commands to the display apparatus by pressing the OK key on the control device.

In some embodiments, a user can input commands to a display apparatus through a control device to cause the display apparatus to display a system menu, which can include a first entry point, such as an option for PiP mode. Users can use the control device to move the focus to the first entry point in the system menu and input control commands to the display apparatus by pressing the OK key on the control device.

If the control command received by the display apparatus can include a key value, the display apparatus can active PiP mode according to the process shown in FIG. 7. The specific steps can include, but are not limited to, the following operations.

S701, determine whether the control command includes the first key value or the second key value.

Based on the system architecture shown in FIG. 5A, the Bluetooth driver or infrared driver can receive key events sent by the control device and send the key events to the framework layer. Alternatively, the application layer receives a click event (such as clicking a second key) and sends the click event to the framework layer. After receiving key events or click events through the phone window manager class in the system services of the framework layer, the display apparatus can determine whether the key value includes the first key value or the second key value.

The display apparatus identifies whether the control command is an input command based on the first key value of the control device. The display apparatus identifies whether the control command is an input command based on the second key value on the virtual keyboard.

S702, when the control command includes the first key value or the second key value, in response to the control command, activate the picture-in-picture mode when the first page supports the picture-in-picture mode.

If the display apparatus identifies that the control command includes a first key value or a second key value, it can determine that the control command is configured to active PiP mode. In response to this control command, the display apparatus can call the PiP method in the page task management service through the phone window manager class to active PiP mode.

If the display apparatus identifies that the control command does not include the first key value and the second key value, it needs to identify whether the control command is a command entered based on the first entry point in the system menu. If the display apparatus determines that the control command is not for activation PiP mode, then PiP mode cannot be activated.

S602, in response to a control command, when the first page supports picture-in-picture mode, shrink a size of the first window and display the second window. The first page is displayed in a shrunken first window and the second page is displayed in the second window.

After activating PiP mode, the size of the first window can be shrunk, allowing the second window with a lower window priority to be exposed. The shrunken first window and the second window in full-screen state remain in the same layer, with the window priority of the shrunken first window still able to be higher than that of the second window in full-screen state. At this point, the shrunken first window serves as the PiP window, while the second window in full-screen state acts as the main window. The first page is displayed within the shrunken first window, and the second page is shown in the second window, enabling the first page to be displayed in PiP mode and the second page in full-screen state, allowing users to view both pages simultaneously.

The display apparatus responds to control commands and identifies whether the first page supports PiP mode. When the display apparatus supports PiP mode on the first page, PiP mode can be activated to ensure its effectiveness.

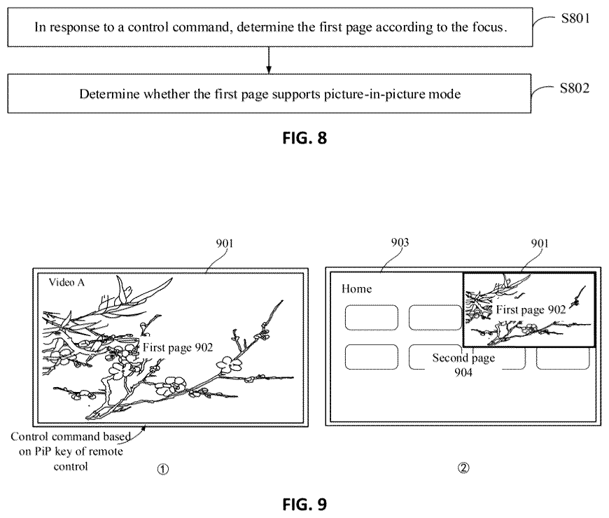

The display apparatus can determine whether the first page supports PiP mode according to the process shown in FIG. 8. The specific steps can include, but are not limited to, the following operations.

S801, in response to a control command, determine the first page according to the focus.

The page with focus, i.e., the page currently being displayed (Activity). Based on the system architecture shown in FIG. 5A, the display apparatus can obtain the root task stack where the focus is located through the page task management service in the system services of the framework layer, and obtain the page in the foreground interactive (resume) state, i.e. the page where the focus is located, through the root task stack. In this embodiment, the page with focus is the first page.

S802, determine whether the first page supports picture-in-picture mode.

Each application can declare pages that support PiP mode in its own manifest file according to its business scenario. This includes recording the support relationship between pages and PiP mode in the manifest file, carrying an identifier on pages that support PiP mode, and recording the correspondence between pages and identifiers in the manifest file. The display apparatus identifies whether the first page supports PiP mode by determining whether the first page is a page declared by the current application to support PiP mode. For example, system services can use the ActivityRecordsupportsPictureInPicture( ) method to determine whether the first page supports PiP mode.

If the display apparatus detects that the first page does not support PiP mode, it will display a prompt message indicating that the first page does not support PiP mode. At this time, the display apparatus does not active PiP mode, that is, it does not change the size of the first window.

In some embodiments, the first window can be an application window, and the first page can include an application page, a live program page, etc. In other embodiments, the first window can be the main operating system window, and the first page can be the Launcher page. For example, the display apparatus can configure the window priority of the main window of the operating system to the highest level. Alternatively, the display apparatus can currently only create the first window and not create a second window. Pages that do not support PiP mode can include launcher pages, etc.

In some embodiments, the display apparatus can display a prompt message in the form of a pop-up window.

If the display apparatus identifies that the page supports PiP mode, that is, the first page supports PiP mode, then the display apparatus can activate PiP mode. For example, a system service can switch the current page to a PiP window display using the enterPictureInPictureMode method of the ActivityTaskManagerService class to active PiP mode.

Before activating PiP mode, the display apparatus identifies whether it is currently in PiP mode. In this embodiment, if the display apparatus can determine that it is not currently in PiP mode, then the display apparatus can activate PiP mode.

Taking a display apparatus 200 as a television and a control device 100 as a remote control as an example, the following embodiments will illustrate how to active PiP mode on a display apparatus.

### Embodiment 1

As shown in \textcircled{1} of FIG. 9, the TV displays the first page 902 in the first window 901, such as video page A, and displays the second page 904 (not shown in \textcircled{1} of FIG. 9) in the second window 903, such as the Launcher page. The first window 901 is in full-screen state. The first window 901 and the second window 903 are in the same layer, and the window priority of the first window 901 is higher than the window priority of the second window 903. In this way, the TV will prioritize displaying the first window 901, and the user can only view the first page 902. The remote control can include a first key, such as the PiP key, by which the user inputs control commands to the TV by pressing the PiP key. After receiving the control command, the TV identifies that the control command includes a first key value, such as PiP, and thus determines that the control command is configured to indicate the activation of PiP mode. The TV responds to the control command by identifying whether the first page 902 supports PiP mode. If the TV identifies that the first page 902 supports PiP mode, the TV then identifies whether it is currently in PiP mode. If the TV detects that it is not currently in PiP mode, then PiP mode can be activated. As shown in \textcircled{2} of FIG. 9, the television shrinks the size of the first window 901 and exposes the second window 903, which has a lower window priority. The television displays the first page 902 in the first window 901 after it has been shrunk in size, and displays the second page 904 in the second window 903 in full-screen state.

### Embodiment 2

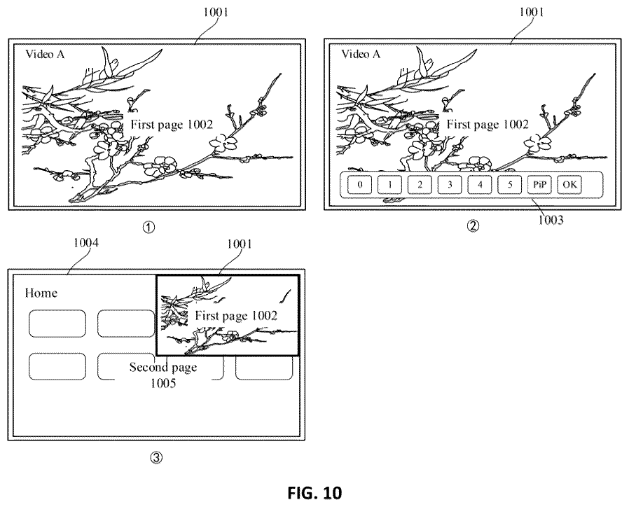

As shown in \textcircled{1} of FIG. 10, the TV displays the first page 1002 in the first window 1001, such as video page A, and displays the second page 1005 (not shown in \textcircled{1} of FIG. 10), such as the Launcher page, in the second window 1004. The first window 1001 is in full-screen state. The first window 1001 and the second window 1004 are in the same layer, and the window priority of the first window 1001 is higher than the window priority of the second window 1004. In this way, the TV will prioritize displaying the first window 1001, and the user can only view the first page 1002. The user can control the TV to display a virtual keyboard 1003 on the first page 1002 using a remote control, as shown in \textcircled{2} of FIG. 10. The virtual keyboard 1003 can include a second key, such as the PiP key. Users can move the focus to the PiP key using the remote control and input control commands to the TV by pressing the OK key on the remote control. After receiving the control command, the TV can identify that the control command includes a second key value, such as PiP, and thus determine that the control command is configured to indicate the activation of PiP mode. The TV can respond to the control command by identifying whether the first page 1002 supports PiP mode. If the TV identifies that the first page 1002 supports PiP mode, the TV then can identify whether it is currently in PiP mode. If the TV identifies that it is not currently in PiP mode, then PiP mode can be activated. As shown in \textcircled{3} of FIG. 10, the television can shrink the size of the first window 1001 and expose the second window 1004, which has a lower window priority. The television can display the first page 1002 in the first window 1001 after being shrunk, and the second page 1005 in the second window 1004 in full-screen state.

### Embodiment 3

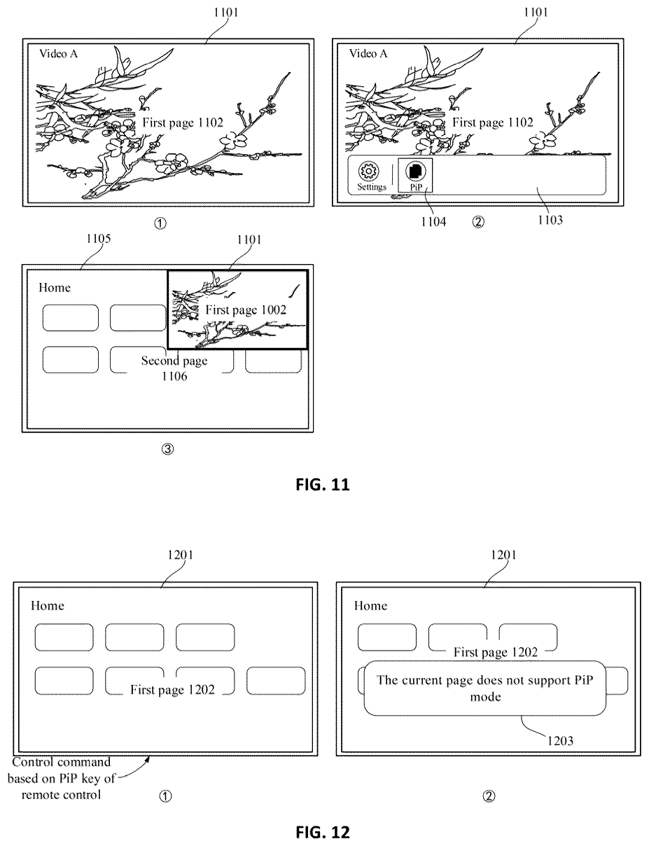

As shown in \textcircled{1} of FIG. 11, the TV can display the first page 1102 in the first window 1101, such as video page A, and display the second page 1106 (not shown in \textcircled{1} of FIG. 11) in the second window 1105, such as the Launcher page. The first window 1101 is in full-screen state. The first window 1101 and the second window 1105 are in the same layer, and the window priority of the first window 1101 is higher than the window priority of the second window 1105. In this way, the TV can prioritize displaying the first window 1101, and the user can only view the first page 1102. The user can control the TV to display the system menu 1103 on the first page 1102 through the remote control, as shown in \textcircled{2} of FIG. 11. The system menu 1103 can be a shortcut menu and can include the first entry point, such as the PiP mode option 1104. The user can move the focus to option 1104 using the remote control and input control commands to the TV by pressing the OK key on the remote control. After receiving the control command, the TV can identify whether the first page 1102 supports PiP mode in response to the control command. If the TV identifies that the first page 1102 supports PiP mode, the TV can identify whether it is currently in PiP mode. If the TV identifies that it is not currently in PiP mode, then PiP mode can be activated. As shown in \textcircled{3} of FIG. 11, the television can shrink the size of the first window 1101 and expose the second window 1105, which has a lower window priority. The television can display the first page 1102 in the first window 1101 after being shrunk, and the second page 1106 in the second window 1105 in full-screen state.

### Embodiment 4

As shown in \textcircled{1} of FIG. 12, the TV displays the first page 1202, such as the Launcher page, in the first window 1201, and displays the second page (not shown in \textcircled{1} of FIG. 12) in the second window. Both the first window 1201 and the second window are in full-screen state. The TV can be configured to set the window priority of the main window of the operating system to the highest level. The first window 1201 and the second window are in the same layer, and the window priority of the first window 1201 is higher than the window priority of the second window. In this way, the TV can prioritize displaying the first window 1201, and the user can only view the first page 1202. The remote control can include a first key, such as the PiP key. Taking the user inputting control commands to the TV based on the PiP key as an example, the TV can respond to the control command by identifying whether the first page 1202 supports PiP mode. If the Launcher page does not support PiP mode, the TV cannot active PiP mode and display a prompt message on the first page 1202. As shown in \textcircled{2} of FIG. 12, the TV can display a prompt message in the form of pop-up window 1203, such as the current page does not support PiP mode.

In some embodiments, the display apparatus is not in PiP mode. The display apparatus has created multiple windows, including at least a first window and a second window, and a first page can be displayed in the first window and a second page can be displayed in the second window. The multiple windows are in the same layer. The window priorities of the first window and second window can be higher than the window priorities of other windows, and the window priority of the first window can be higher than the window priority of the second window. The first window is in full-screen state. In some embodiments, the second window can also be in full-screen state.

In some embodiments, the display apparatus is not in PiP mode. The display apparatus has created a first window and a second window, and displays the first page in the first window and the second page in the second window. The first window and the second window can be in different layers. The priority of the layer to which the first window belongs can be higher than the priority of the layer to which the second window belongs. The first window is in full-screen state. In some embodiments, the second window can also be in full-screen state. Therefore, the display apparatus prioritizes displaying the first page in the first window. In this state, users can only watch the first page and cannot watch the second page. The display apparatus can be activated in PiP mode by referring to steps S601-S602, S701-S702, and S801-S802, which will not be elaborated here. The main difference is that the first window after being shrunk and the second window in full-screen state are still in different layers. The priority of the layer to which the shrunken first window belongs is still higher than the priority of the layer to which the second window in full-screen state belongs.

In some embodiments, the display apparatus is not in PiP mode. The display apparatus has created multiple windows, including at least a first window and a second window, and displays a first page in the first window and a second page in the second window. The first window is in full-screen state. In some embodiments, the second window can also be in full-screen state. The multiple windows are in at least two layers. The first window and the second window are in different layers. The priority of the layer to which the first window belongs can be higher than the priority of the layer to which the second window belongs, and the priority of the layer to which the second window belongs has a higher level than or equal to the priorities of the layer to which the other windows belong. If the priority of the layer to which the second window belongs is equal to the priorities of the layer to which the other windows belong, then the window priority of the second window is higher than the window priorities of other windows.

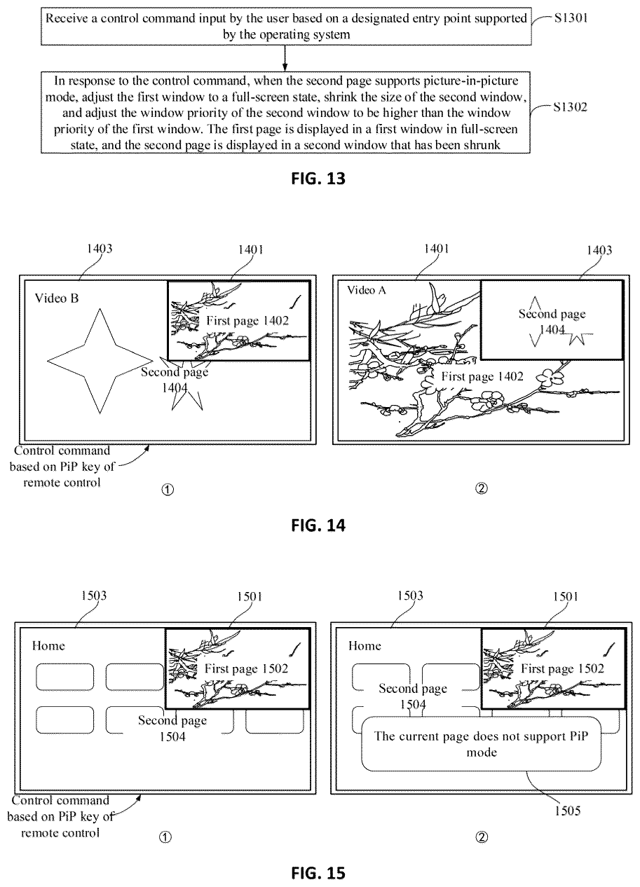

In some embodiments, the display apparatus is in PiP mode. The display apparatus displays the first page in the first window and the second page in the second window. The second window is in full-screen state, and the size of the first window is smaller than the size of the second window. The first window and second window are in the same layer, and the window priority of the first window is higher than the window priority of the second window. Therefore, the display apparatus prioritizes displaying the first page in the first window. In this state, the first window obscures the second window. The display apparatus can adjust the PiP mode according to the process shown in FIG. 13. The specific steps can include, but are not limited to, the following operations.

S1301, receive a control command input by the user based on a designated entry point supported by the operating system.

This control command is configured to indicate the activation of PiP mode.

Step S1301 is similar to step S601, and will not be described in detail here.

The process of display apparatus identifying control commands is similar to steps S701-S702, and will not be described in detail here.

S1302, in response to the control command, when the second page supports picture-in-picture mode, adjust the first window to a full-screen state, shrink the size of the second window, and adjust the window priority of the second window to be higher than the window priority of the first window. The first page is displayed in a first window in full-screen state, and the second page is displayed in a second window that has been shrunk.

When the display apparatus is in PiP mode, adjusting the PiP mode to switch the page displayed in PiP mode means adjusting the current main window to a PiP window and displaying the page in the current main window in the adjusted PiP window; adjusting the current PiP window to the main window and displaying the page in the current PiP window in the adjusted main window. In this context, the current main window is the second window, and the current PiP window is the first window. After activation PiP mode, the first window is adjusted to the full-screen state, the size of the second window is reduced, and the window priority of the second window is adjusted to be higher than the window priority of the first window to prioritize the display of the second window. The first window is then adjusted to the main window, and the second window is adjusted to the PiP window. The display apparatus displays the first page in the adjusted first window and the second page in the adjusted second window. Moreover, since the size of the second window is smaller than that of the first window, the display apparatus can display the pages in the first window and the second window simultaneously, so as to switch the first page displayed in PiP mode to the second page.

In some embodiments, the second window can be the main operating system window, and the second page can be the Launcher page. In some embodiments, the second window can be an application window, and the second page can include an application page, a live program page, etc. Pages that do not support PiP mode can include launcher pages, etc.

Before activation PiP mode, the display apparatus identifies whether the second page supports PiP mode. This process can be referred to in steps S801-S802, and will not be elaborated here.

If the display apparatus identifies that the second page does not support PiP mode, it will display a prompt message indicating that the second page does not support PiP mode. At this time, the display apparatus does not switch to displaying the page in PiP mode.

In some embodiments, the display apparatus can display a prompt message in the form of a pop-up window.

Before adjusting the PiP mode, the display apparatus identifies whether it is currently in PiP mode. In this embodiment, if the display apparatus determines that it is currently in PiP mode, the display apparatus can initiate an adjustment of the PiP mode to switch the page displayed in PiP mode.

Taking the display apparatus 200 as a television and the control device 100 as a remote control, the remote control can include a first key, such as a PiP key. Taking the user inputting control commands to the television based on the PiP key as an example, the process of switching the display apparatus to display a page in PiP mode will be explained with the following embodiments.

### Embodiment 5

As shown in \textcircled{1} of FIG. 14, the TV displays the first page 1402 in the first window 1401, such as video page A, and displays the second page 1404 in the second window 1403, such as video page B. The second window 1403 is in a full-screen state, and the size of the first window 1401 is smaller than the size of the second window 1403. The first window 1401 and the second window 1403 are in the same layer. The window priority of the first window 1401 is higher than the window priority of the second window 1403, that is, the first page 1402 is displayed in PiP mode. The TV responds to the control commands input by the user based on the PiP key and identifies whether the second page 1404 supports PiP mode. If the TV determines that the second page 1404 supports PiP mode, the TV can identify whether it is currently in PiP mode. If the TV determines that it is in PiP mode, it can switch to displaying the page in PiP mode. As shown in \textcircled{2} of FIG. 14, the TV can adjust the first window 1401 to a full-screen state, shrink the size of the second window 1403, and adjust the window priority of the second window 1403 to be higher than the window priority of the first window 1401. The television can display the second page 1404 in the shrunken second window 1403 and the first page 1402 in the full-screen first window 1401, thereby switching the display of the first page 1402 in PiP mode to the display of the second page 1404.

### Embodiment 6

As shown in \textcircled{1} of FIG. 15, the TV can display the first page 1502 in the first window 1501, such as video page A, and display the second page 1504 in the second window 1503, such as the Launcher page. The second window 1503 is in a full-screen state, and the size of the first window 1501 is smaller than the size of the second window 1503. The first window 1501 and the second window 1503 are in the same layer. The window priority of the first window 1501 is higher than the window priority of the second window 1503, that is, the first page 1502 is displayed in PiP mode. The TV can respond to the control commands input by the user through the PiP key and identify whether the second page 1504 supports PiP mode. If the TV determines that the second page 1504 does not support PiP mode, the TV cannot switch to the page displayed in PiP mode, nor can it display a prompt message. As shown in \textcircled{2} of FIG. 15, the TV can display a prompt message in pop-up window 1505, such as “The current page does not support PiP mode”.

In some embodiments, the display apparatus is in PiP mode. The display apparatus has created multiple windows, which can include a first window and a second window, and displays a first page in the first window and a second page in the second window. The second window is in a full-screen state, and the size of the first window is smaller than the size of the second window. These multiple windows are in the same layer, and the window priorities of the first window and second window are both higher than the window priorities of other windows. The window priority of the first window is higher than the window priority of the second window. When adjusting the PiP mode, the display apparatus can adjust the window priority of the second window to be higher than the window priority of the first window, and ensure that the window priority of the first window is higher than the window priorities of other windows.

In some embodiments, the display apparatus is in the PiP mode. The display apparatus can display the first page in the first window and the second page in the second window. The second window is in a full-screen state, and the size of the first window is smaller than the size of the second window. The first window and second window are in different layers, and the priority of the layer to which the first window belongs is at a higher level than the priority of the layer to which the second window belongs. Therefore, the display apparatus prioritizes displaying the first page in the first window. In this state, the first window obscures the second window. The display apparatus can adjust the PiP mode by referring to steps S1301-S1302. The main difference from step S1302 is that the display apparatus can adjust the priority of the layer to which the second window belongs to be higher than the priority of the layer to which the first window belongs, so as to prioritize the display of the second window. In this state, the second window obscures the first window.

In some embodiments, the display apparatus is in the PiP mode. The display apparatus has created multiple windows, including at least a first window and a second window, and displays a first page in the first window and a second page in the second window. The second window is in the full-screen state, and the size of the first window is smaller than the size of the second window. The multiple windows are in at least two layers. The first window and the second window are in different layers. The priority of the layer to which the first window belongs is higher than the priority of the layer to which the second window belongs, and the priority of the layer to which the second window belongs is higher than or equal to the priorities of the layers to which the other windows belong. If the priority of the layer level to which the second window belongs is equal to the priorities of the layers to which the other windows belong, then the window priority of the second window is higher than the window priorities of other windows. When adjusting PiP mode, the display apparatus can adjust the priority of the layer to which the second window belongs to be higher than the priority of the layer to which the first window belongs, and ensure that the priority of the layer to which the first window belongs is higher than the priorities of the layers to which other windows belong, or when the priority of the layer to which the first window belongs is the same as the priorities of the layers to which other windows belong, adjust the window priority of the first window to the highest level within that layer.

Typically, when a display apparatus is in the PiP mode, the width or height of the PiP window is fixed. When displaying a page within the PiP window, the size of the PiP window can only be adjusted by changing its aspect ratio, based on this fixed width or height. Taking the first window after shrinking as the PiP window as an example, the size of the first window after shrinking is relatively fixed. Different pages have different requirements for image size. The size of the PiP window cannot match the size of the page being displayed, which will cause problems such as the page displayed in the PiP window not being fully displayed, not filling the PiP window, and being out of proportion. Based on the system architecture shown in FIG. 5B, the display apparatus according to some embodiments of the present application can, after activation PiP mode, make the size of the PiP window match the image size of the page displayed within it, so as to improve the display quality of the page within the PiP window. The following section explains the customization options for PiP parameter classes, PiP tools, and Wmshell.

The PiP parameter class can represent the parameters used by a page of an application to initialize (e.g., when the current page enters PiP mode) and update (e.g., when the current PiP window needs to be resized) in PiP mode. It can implement a Parcelable interface, so PiP parameters can be serialized into content and Inter Process Communication (IPC) can be performed. In the customized PiP parameter class, add width and height attributes, and modify the writeToParcel and Parcel constructors to ensure that the width and height can be serialized and deserialized normally. Because the PiP parameter class is constructed using the builder pattern, it is also necessary to add corresponding properties and methods to its inner class (such as Builder).

The PiP tool can serve as a bridge between the application layer and the framework layer. It primarily provides two methods for displaying the PiP window: determining the size of the PiP window when the current page enters PiP mode, and dynamically adjusting the size of the PiP window when the PiP window is displayed. The PiP tool can hold a reference to the application's pages. When the current page enters PiP mode, it can assemble the required image size for the current page, i.e., the PiP parameters, and then call the page's native interface, such as the enterPictureInPictureMode method, carrying the PiP parameters, to put the current page into PiP mode. Based on the extended PiP parameter class, upper-layer development cannot directly call customized methods. In some embodiments of the present application, the PiP tool can use reflection mechanism to call the setting method. When dynamically adjusting the size of the PiP window, it is possible to assemble the changed PiP parameters, pass in the changed width and height, and update the size of the PiP window by calling the page's native interface, such as the setPaintInPictureParams method.

In some embodiments, WMS customization can be performed within the PiP subpackage. After the PiP tool calls the enterPictureInPictureMode method or setPictureInPictureParams method of the page, it passes the PiP parameter to WMS. When the system user interface (SystemUI) starts up, it initializes Wmshell through the system user interface factory (SystemUIFactory) class and calls the init method of the shell initialization (ShellInit) class. In its implementation class, such as the ShellInitImpt class, it calls the registerOrganizer method of the shell task organizer (ShellTaskOrganizer) class. ShellTaskOrganizer is a subclass of TaskOrganizer. Ultimately, the TaskOrganizer class registers the callback with WindowManagerService through the registerTaskOrganizer method of the registerTaskOrganizerController. When a task changes, TaskOrganizer can receive the callback from WMS and then call the corresponding method within TaskOrganizer. For example, the onTaskAppeared method can be called back when a Task appears; the onTaskInfoChanged method can be called back when a Task changes.

As a subclass of TaskOrganizer, ShellTaskOrganizer can receive these callbacks and can maintain a sparse array of task listeners. Within the callback method of ShellTaskOrganizer, the TaskListener object can be retrieved from the SparseArray and the corresponding method of that object can be executed. ShellTaskOrganizer, as a subclass of TaskOrganizer, can receive these callbacks and maintain a sparse array object (SparseArray) of TaskListeners. Within the ShellTaskOrganizer callback method, the TaskListener object can be retrieved from SparseArray and the method corresponding to the TaskListener object can be executed.

In Wmshell, TaskListener registration of PiP is done in the constructor of the PiPTaskOrganizer class. When WMS triggers a callback, PiPTaskOrganizer can receive the corresponding callback.

In summary, customization of Wmshell PiP mainly involves two parts: the forwarding processing of WMS callbacks, which can include the resolution of image size, i.e., the size of the PiP window, and the forwarding rules of callbacks. The resolution of the size of the PiP window can be the storage and calculation of image size, and the adjustment of the PiP window.

This section explains the forwarding process for WMS callbacks.

As described above, the callback notification for tasks in WMS is in Wmshell ShellTaskOrganizer. The PiPTaskOrganizer class registers the TaskLisener callback for ShellTaskOrganizer, so PiPTaskOrganizer can receive the corresponding callback method. In some embodiments of the present application, two callback methods can be included: onTaskAppended (ActivityManager.RunningTaskInfo info, SurfaceControl leash), and, onTaskInfoChanged (ActivityManager.RunningTaskInfo info).

The onTaskAppeared method is called when the Task appears. RunningTaskInfo is a description of the Task class and holds a PiP parameter object. Therefore, within the onTaskAppeared method, the PiP parameter can be obtained, and then the event notification and forwarding can be performed through the PiPParamsChangedForward object of the PiPTaskOrganizer class.

The OnTaskInfoChanged method is called back when the Task changes, such as when the window mode changes or the parameters change. When resizing the PiP window, the Wmshell PiPTaskOrganizer can receive the callback by updating the PiP parameter object and calling the setPictureInPictureParams method of the page. Because onTaskInfoChanged can also obtain the RunningTaskInfo class, it can also obtain the PiP parameter, parse the PiP parameter, that is, the image size, and call the appNewPaintInPictureParams method to adjust the size of the PiP window. On the one hand, when executing the applyNewPaintInPictureParams method, it is determined whether the aspect ratio corresponding to the PiP parameter has changed, that is, whether the page scale has changed. If it is determined that a change has occurred, the event can be forwarded through the PiPParamsChangedFForwarder object. On the other hand, when executing the applyNewPaintInPictureParams method, it is determined whether the width and height corresponding to the PiP parameter have changed, that is, whether the image size has changed. If it is determined that a change has occurred, the event can be forwarded through the PiPParamsChangedFForwarder object.

Below is an explanation of the storage, calculation, and adjustment of the PiP window for the custom image size (PiP parameter) of the current page.

The OnTaskAppeared callback of PiPTaskOrganizer first calls the setBoundsStateForEntry method to set the initial state of the PiP boundary state (PiPBoundsStates), which can include the componentName, aspect ratio, etc. PiPBoundsStates is a state holding class for the current PiP window. It is possible to extend the properties of PiPBoundsStates by adding a width and height field to store the width and height of PiP windows that match the image size, and assign values to the PiP window size based on the stored width and height in the setBoundsStateForEntry method.

After calling the setBoundsStateForEntry point method, the onTaskAppeared method can also call the getEntry pointDestinationBounds method of the PiP boundary algorithm (PiPBoundsAlgorithm) to get the target position of the PiP window. The return type of this method is Rect, and the coordinates and size of the PiP window can be directly specified through this method. By using the PiPBoundsAlgorithm algorithm, a judgment logic is added when calling getEntry pointDestinationBounds. When the PiPBoundsState object is set to a custom width and height, the width and height return the custom width and height.

After obtaining the coordinates and size of the PiP window, the onTaskAppeared method can specifie the plan to dynamically adjust the PiP (scheduleAnimateResizePiP) method and notifie the WindowManagerService to redraw the PiP window according to the currently requested width and height.

When resizing the PiP window, the PiPTaskOrganizer class eventually calls the applyNewPictureInPictureParams method. In some embodiments of the present application, the applyNewPictureInPictureParams method is customized by adding modifications to the width and height of PiPBoundsState so that the size of the PiP window can be modified to the adjusted size.

Forward the event using the notifyAspectRatioChanged method of PipParamsChangedFForwarder. Callback listening for PiPParamsChangedFForwarder can be set in PiPCntrollers such as TvPiPCntroller, to notify WindowManagerial Service to update the size of the PiP window based on the width and height of PiPBoundsState by updating the fixed task stack (updatePinnedStack) method in the notifyAspectRatioChanged method.

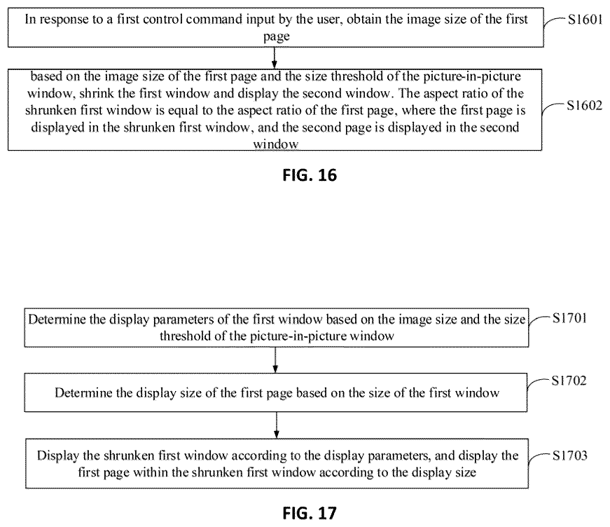

In some embodiments, the display apparatus is not in the PiP mode. The display apparatus has created a first window and a second window, and displays the first page in the first window and the second page in the second window. The first window is in a full-screen state. The first window and the second window can be in the same layer, and the window priority of the first window can be higher than the window priority of the second window. Alternatively, the display apparatus has created a first window and a second window, and displays the first page in the first window and the second page in the second window. Both the first window and second window are in the full-screen state. The first window and second window can be in different layers, and the priority of the layer to which the first window belongs can be at a higher level than the priority of the layer to which the second window belongs. In some embodiments, the second window can also be in the full-screen state. Based on the system architecture shown in FIG. 5B, the display apparatus can display the PiP window according to the process shown in FIG. 16. The specific steps can include, but are not limited to, the following operations.

S1601, in response to a first control command input by the user, obtain the image size of the first page.

The first control command is configured to indicate whether PiP mode is activated.

Before acquiring the image size of the first page, the display apparatus determines whether to active the PiP mode. This process is similar to steps S601-S602, S701-S702, S801-S802 and related content, and will not be elaborated here. At this time, the first control command is the control command input by the user based on the designated entry point supported by the operating system. In other embodiments, the first control command can also be a control command input through an entry point provided by the application. It is understood that the present application does not limit the input method of the first control command.

After confirming that PiP mode is activated, the display apparatus can obtain the image size of the first page in the PiP mode. The image size of the first page can be a custom size defined by the application. If all pages of the first page are displayed within the PiP window, the image size of the first page can be the size of all those pages, i.e., the page size. If a portion of the first page, such as a video frame, is displayed within the PiP window, the size of the first page can be the same as the size of the video frame.

When the display apparatus actives the PiP mode, when the application to which the first page belongs (such as the first application) enters PiP mode through the PiP tool, the image size of the first page in PiP mode is passed, thereby passing the PiP parameter object to WMS. Register a WMS listener in Wmshell. When the PiP task of the first application occurs, WMS can send the parameter information back to the registered Wmshell, thereby activating the monitoring of the first application. After receiving the listener, Wmshell can obtain the PiP parameter object constructed based on the size parameters passed by the first application when entering PiP mode. The image size of the first page can be obtained by parsing the PiP parameter object.

S1602, based on the image size of the first page and the size threshold of the picture-in-picture window, shrink the first window and display the second window. The aspect ratio of the shrunken first window is equal to the aspect ratio of the first page, where the first page is displayed in the shrunken first window, and the second page is displayed in the second window.

The size thresholds for the PiP window can include the width range of the PiP window, which can be greater than or equal to one-third of the width of the display area of the monitor, and less than or equal to half the width of the display area of the monitor. The size thresholds for the PiP window can further include the height range of the PiP window, which can be greater than or equal to one-third of the height of the display area of the monitor, and less than or equal to half the height of the display area of the monitor. The size thresholds for the PiP window can include both the width and height ranges. The size threshold of the PiP window can be configured to prevent the PiP window from being too large or too small. It should be noted that the aforementioned ratios are merely examples and can be set according to actual needs; the present application does not impose any specific limitations.

The display apparatus can shrink the first window, and the shrunken first window matches the image size of the first page, that is, the aspect ratio of the shrunken first window is equal to the aspect ratio of the first page, so as to ensure the image ratio of the first page in the shrunken first window; the shrunken first window meets the size threshold of the PiP window, so as to avoid the first window being too large or too small, which would affect the user's viewing experience. After the display apparatus shrinks the first window, it exposes the second window, which has a lower window priority, to enter the PiP mode.

The display apparatus can shrink the first window according to the process shown in FIG. 17. The specific steps can include, but are not limited to, the following operations.

S1701, determine the display parameters of the first window based on the image size and the size threshold of the picture-in-picture window.

This display parameter can include the size and display position of the shrunken first window.

The display position of the shrunken first window can be a preset position, such as the upper left corner, upper right corner, lower left corner, lower right corner of the monitor, etc.

The size of the shrunken first window meets the size threshold of the PiP window, and the aspect ratio of the shrunken first window is equal to the aspect ratio of the first page. Based on the image size of the first page, the required aspect ratio of the first page can be determined, and then the aspect ratio of the shrunken first window can be determined. For example, the image size of the first page can be w1×h1, then the aspect ratio of the first page can be w1/h1, and the aspect ratio of the shrunken first window can also be w1/h1.

In some embodiments, if the image size of the first page meets the size threshold of the PiP window, then the size of the shrunken first window can be consistent with the image size of the first page, that is, the width of the shrunken first window is equal to the width of the first page, and the height of the shrunken first window is equal to the height of the first page. For example, if the image size of the first page is w1×h1, which meets the size threshold of the PiP window, then the size of the shrunken first window can also be w1×h1.

In some embodiments, the image size of the first page does not meet the size threshold of the PiP window. For example, if the image size of the first page is too large, the size of the shrunken first window can be scaled down proportionally to the image size of the first page. For example, if the image size of the first page is w1×h1, which does not meet the size threshold of the PiP window, and the image size of the first page is too large, then the size of the first window after shrinking can be the proportionally shrunk size, such as (½*w1)×(½*h1).

In some embodiments, the image size of the first page does not meet the size threshold of the PiP window. For example, if the image size of the first page is too small, the size of the shrunken first window can be proportionally enlarged to the image size of the first page. For example, if the image size of the first page is w1×h1, which does not meet the size threshold of the PiP window, and the image size of the first page is too small, then the size of the first window after shrinking can be the size of the proportionally enlarged one, such as (2*w1)×(2*h1).

Display apparatus can determine the callback method. In some embodiments, the display apparatus can determine the callback method as the callback method that occurs when the task occurs. When this callback method is executed, the specific position of the shrunken first window can be calculated based on the image size using the PiP boundary algorithm.

S1702, determine the display size of the first page based on the size of the first window.

The display size of the first page can be the size of the image displayed in the shrunken first window, which matches the size of the shrunken first window.

S1703, display the shrunken first window according to the display parameters, and display the first page within the shrunken first window according to the display size.

The first window is shrunk to a PiP window by using WMS to calculate the display parameters, and a second window with a lower window priority is exposed. The first page is displayed in the first window according to the display size, and the second page is displayed in the second window.

Based on the above method, when PiP mode is activated, the restrictions on the PiP window can be lifted, allowing the size of the PiP window to match the image size of the page displayed within it.

In some embodiments, if the display apparatus does not obtain the image size of the first page, the size of the first window is shrunk to a preset size.

If the display apparatus does not obtain the image size of the first page, it can be assumed that the first page does not have a custom image size, that is, the first page has no special requirements for the image size. The display apparatus can shrink the size of the first window to a preset size, which can be one of one or more fixed width and height combinations. The preset size can also be a width and height combination calculated based on one of one or more fixed widths or heights and one of one or more fixed aspect ratios.

Taking a television as an example, the process of displaying the PiP window when the display apparatus 200 enters the PiP mode will be explained using the following embodiments.

### Embodiment 7

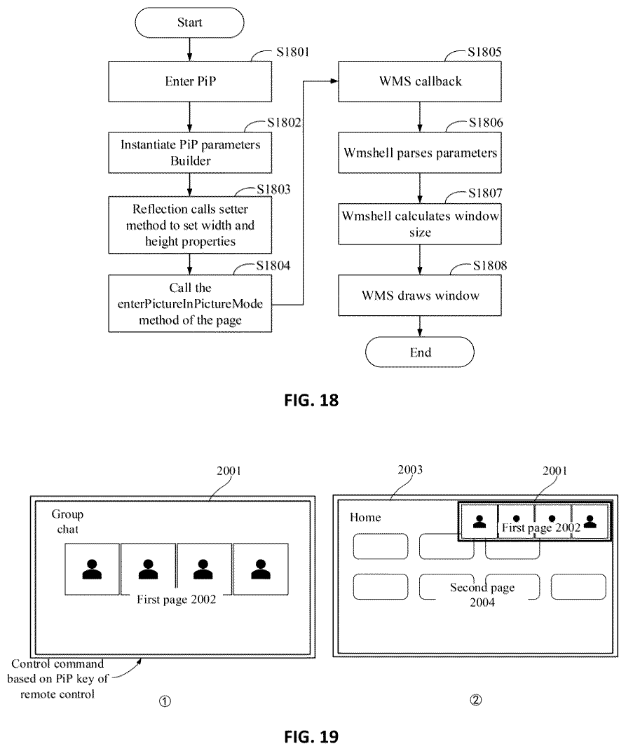

Combining the process shown in FIG. 18, as shown in \textcircled{1} of FIG. 19, the TV displays the first page 2002 in the first window 2001, such as a multi-person chat page, and displays the second page 2004 (not shown in \textcircled{1} of FIG. 19) in the second window 2003, such as the Launcher page. The first window 2001 is in the full-screen state. The first window 2001 and the second window 2003 are in the same layer, and the window priority of the first window 2001 is higher than the window priority of the second window 2003. Therefore, the television prioritizes displaying in the first window 2001. The TV responds to the first control command input by the user and determines whether to active the PiP mode. This process can be referred to in Embodiments 1 to 4, and will not be elaborated here. If the TV confirms that PiP mode is activated, the TV enters PiP mode (S1801) and obtains the image size of the first page 2002, such as width w1, height h1, and aspect ratio 21:3. Based on the image size, instantiate the PiP parameter object using the Builder class (S1802). Reflection calls setter method to set width and height properties (S1803). The enterPictureInPictureMode method of the page is called (S1804), which is called back by WMS (S1805). Wmshell parses the PiP parameters (S1806) and calculates the display parameters of the shrunken first window 2001 based on the image size (S1807). For example, if the shrunken first window 2001 is displayed in the upper middle area of the monitor, the width of the shrunken first window 2001 is w2 and the height is h2. This size meets the size threshold of the PiP window, and w2/h2=21:3. The window is drawn by WMS (S1808), as shown in \textcircled{2} of FIG. 19. The first window 2001 is shrunk and the second window 2003 is exposed. The first window, 2001, after being shrunk in size, is displayed in the upper right corner. The television displays the first page 2002 within the shrunken first window 2001. The display size of the first page 2002 matches the width w2 and the height h2. The second page 2004 is displayed within the second window 2003.

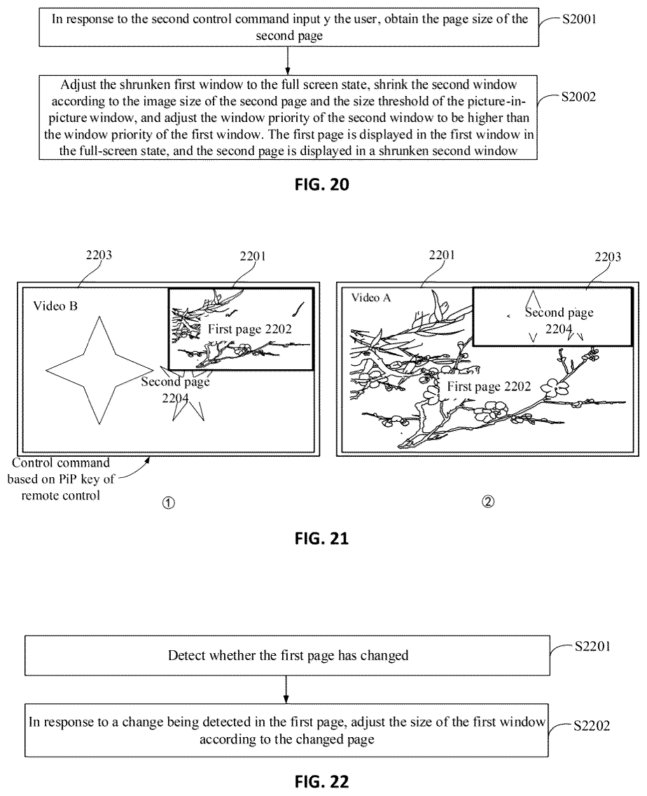

In some embodiments, the display apparatus is already in the PiP mode. The display apparatus has created a first window and a second window, and displays the first page in the first window and the second page in the second window. The second window is in the full-screen state, and the size of the first window is smaller than the size of the second window. The first window and the second window can be in the same layer, and the window priority of the first window can be higher than the window priority of the second window. Alternatively, the first window and the second window can be in different layers, and the priority of the layer to which the first window belongs can be at a higher level than the priority of the layer to which the second window belongs. Based on the system architecture shown in FIG. 5B, the display apparatus can adjust the PiP mode according to steps S1301-S1302. At this time, the display apparatus switches to displaying the page in the PiP mode. During the process of switching to displaying the page in the PiP mode, the display apparatus can display the switched PiP window according to the process shown in FIG. 20. The specific steps can include, but are not limited to, the following operations.

S2001, in response to the second control command input y the user, obtain the page size of the second page.

The second control command is configured to indicate the page to be displayed in the PiP mode.

S2002, adjust the shrunken first window to the full-screen state, shrink the second window according to the image size of the second page and the size threshold of the picture-in-picture window, and adjust the window priority of the second window to be higher than the window priority of the first window. The first page is displayed in the first window in the full-screen state, and the second page is displayed in a shrunken second window.

Steps S2001-S2002 are similar to steps S1301-S1302. The process of the display apparatus acquiring the image size of the second page is similar to step S1601, and the process of the display apparatus shrinking the second window is similar to the process of shrinking the first window in step S1602. These will not be described in detail here.

Taking a television as an example, the process of displaying the PiP window after switching pages in PiP mode will be explained using the following embodiments.

### Embodiment 8

Referring to the process shown in FIG. 18, as shown in\textcircled{1} of FIG. 21, the television displays the first page 2202, such as video page A, in the first window 2201, and the second page 2204, such as video page B, in the second window 2203. In this embodiment, taking the first window 2201 and the second window 2203 as being in the same layer, with the window priority of the first window 2201 being higher than the window priority of the second window 2203, the second window 2203 is in the full-screen state, and the size of the first window 2201 is smaller than the size of the second window 2203, that is, the first page 2202 is displayed in the PiP mode. The TV responds to the second control command input by the user and determines whether to switch the page displayed in the PiP mode. This process can be referred to in Embodiments 5 to 6, and will not be elaborated here. If the TV determines to switch to the page displayed in the PiP mode, the TV obtains the image size of the second page 2204, and as shown in \textcircled{2} of FIG. 21, adjusts the first window 2201 to the full-screen state, shrinks the second window 2203, and adjusts the window priority of the second window 2203 to be higher than the window priority of the first window 2201. The aspect ratio of the shrunken second window 2203 is equal to the aspect ratio of the second page 2204, and the size of the shrunken second window 2203 meets the size threshold of the PiP window. Specifically, the first page 2202 is displayed in the first window 2201, and the second page 2204 is displayed in the second window 2203. This process can be referred to in Embodiment 7, and will not be elaborated here.

In some embodiments, the display apparatus is already in PiP mode, such as

when the display apparatus can enter PiP mode according to steps S1601-S1602. At this time, the display apparatus displays the first page in the first window and the second page in the second window. The second window is in the full-screen state, and the size of the first window can be smaller than the size of the second window. The display apparatus can dynamically adjust the size of the first window based on changes in the pages within the first window. The display apparatus can adjust the size of the PiP window according to the process shown in FIG. 22. The specific steps can include, but are not limited to, the following operations.

S2201, detect whether the first page has changed.

The changes of the first page can include changes in screen orientation and changes in the content displayed.

The screen display orientation can include landscape and portrait modes. In landscape mode, the width of the page can be greater than the height of the page; in portrait mode, the height of the page can be greater than the width of the page.

Different types of content require different image sizes. For example, movies and TV series require different image sizes, as do videos and multi-person chats.

S2202, in response to a change being detected in the first page, adjust the size of the first window according to the changed page.

If a change is detected in the first page, it means that the current size of the first window cannot match the required image size of the changed page, which will affect the display quality of the changed page. To ensure the display quality of the changed page, the display apparatus can adjust the size of the first window according to the changed page so that the size of the first window can match the image size required by the changed page, that is, the aspect ratio of the adjusted first window can be equal to the aspect ratio of the changed page.

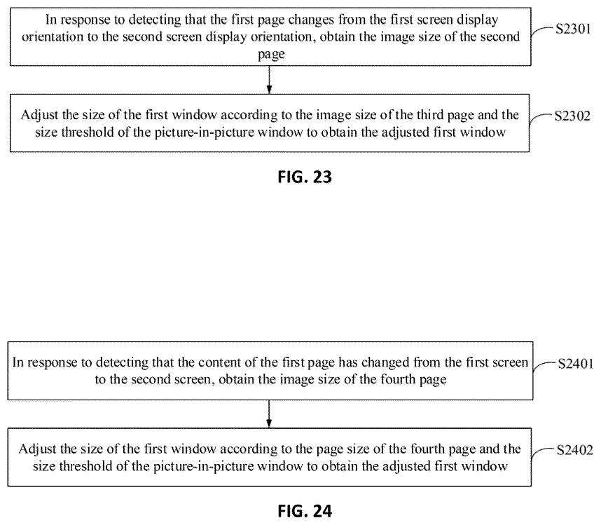

The display apparatus can adjust the size of the PiP window according to the process shown in FIG. 23. The specific steps can include, but are not limited to, the following operations.

S2301, in response to detecting that the first page changes from the first screen display orientation to the second screen display orientation, obtain the image size of the second page.

The first screen can be displayed in landscape mode, and the second screen can be displayed in portrait mode; or, the first screen can be displayed in portrait mode, and the second screen can be displayed in landscape mode.

The third page can be the page after the first page is changed to the second screen display orientation. The content of the third page can be the same as or different from the first page (e.g., different page layout).

The process of the display apparatus obtaining the image size of the third page can be referred to in step S1601, which will not be repeated here. If the display apparatus determines that only the screen display orientation has changed, then the height of the first window before adjustment can be determined as the width of the first window after adjustment, and the width of the first window before adjustment can be determined as the height of the first window after adjustment.

S2302, adjust the size of the first window according to the image size of the third page and the size threshold of the picture-in-picture window to obtain the adjusted first window.

The aspect ratio of the adjusted first window can be equal to the aspect ratio of the third page, and the aspect ratio of the adjusted first window can meet the size threshold of the PiP window.

In this way, when the screen orientation of the page in the PiP window changes, the size of the PiP window can be automatically adjusted so that the size of the adjusted PiP window can match the image size of the changed page, thereby ensuring the display quality of the changed page.

The display apparatus can adjust the size of the PiP window according to the process shown in FIG. 24. The specific steps can include, but are not limited to, the following operations.

S2401, in response to detecting that the content of the first page has changed from the first screen to the second screen, obtain the image size of the fourth page.

The fourth page can be the same page as the second screen, and the screen orientation of the fourth page can be the same as the first page.

The process of the display apparatus obtaining the image size of the fourth page can be referred to in step S1601, which will not be repeated here.

S2402, adjust the size of the first window according to the page size of the fourth page and the size threshold of the picture-in-picture window to obtain the adjusted first window.

The aspect ratio of the adjusted first window can be equal to the aspect ratio of the fourth page, and the aspect ratio of the adjusted first window can meet the size threshold of the PiP window.

In this way, when the content of the page in the PiP window changes, the size of the PiP window can be automatically adjusted so that the size of the adjusted PiP window matches the size of the changed page, thereby ensuring the display quality of the changed page.

Taking the display device 200 as an example of a television, the process of adjusting the PiP window on the display device 200 will be explained with the following embodiments.

### Embodiment 9

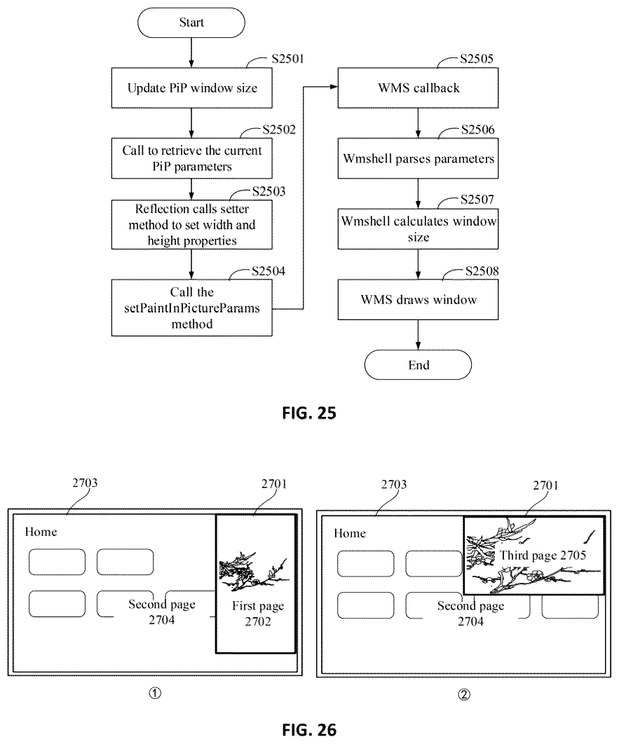

Based on the process shown in FIG. 25, as shown in \textcircled{1} of FIG. 26, the TV displays the first page 2702 in the first window 2701, such as video page A, and displays the second page 2704 in the second window 2703, such as the Launcher page. The second window 2703 is in the full-screen state, and the size of the first window 2701 is smaller than the size of the second window 2703. Taking the first window 2701 and the second window 2703 as being in the same layer, with the window priority of the first window 2701 being higher than the window priority of the second window 2703, the first page 2702 is displayed in the PiP mode. As shown in \textcircled{1} of FIG. 26, the first page 2702 is the first screen display direction, such as portrait display. If the TV detects a change in the screen display orientation of the first page 2702, such as a change to the second screen display orientation, such as landscape display, the TV can determine to adjust the size of the first window 2701, that is, update the PiP window size (S2501). Obtain the image size of the third page 2705, call the current PiP parameters (S2502), use reflection to call the setter method to set the width and height attributes (S2503), and call the setPictureInPictureParams method (S2504). The process is initiated by WMS callback (S2505), and Wmshell parses the PiP parameters (S2506). Wmshell then calculates the adjusted size of the first window 2701 based on the image size (S2507). For example, the width of the adjusted first window 2701 is equal to the height of the first window 2701 before adjustment, and the height of the adjusted first window 2701 is equal to the width of the first window 2701 before adjustment. The aspect ratio of the first window 2701 after adjustment is equal to the aspect ratio of the third page 2705. The window (S2508) is drawn by WMS, as shown in \textcircled{2} of FIG. 26, and the adjusted first window 2701 is displayed. The adjusted first window 2701 is also displayed in landscape mode, and the third page 2705 is displayed within the adjusted first window 2701.

### Embodiment 10

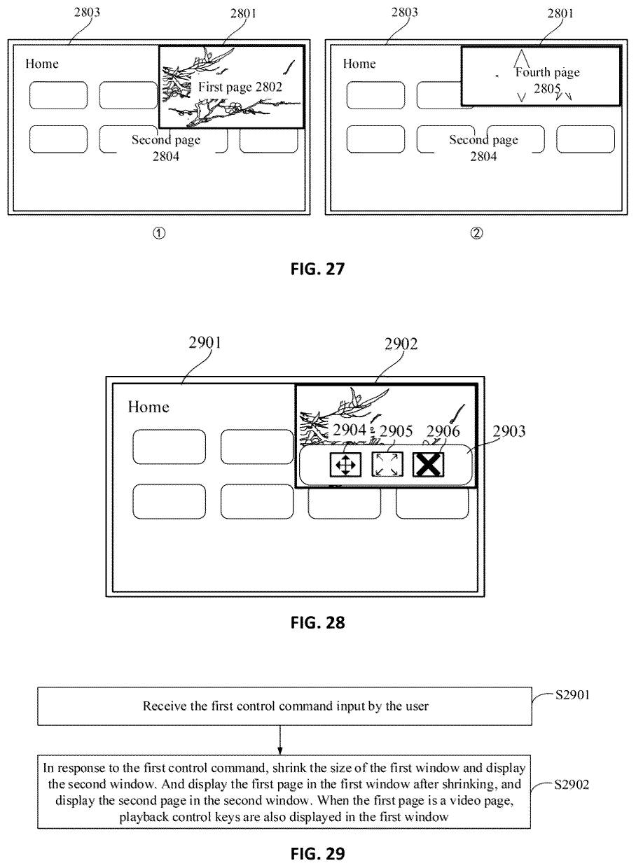

Referring to the process shown in FIG. 25, as shown in \textcircled{1} of FIG. 27, the TV displays the first page 2802 in the first window 2801, such as video page A, and displays the second page 2804 in the second window 2803, such as the Launcher page. The second window 2803 is in the full-screen state. The size of the first window 2801 is smaller than the size of the second window 2803. Taking the first window 2801 and the second window 2803 as being in the same layer, with the window priority of the first window 2801 being higher than the window priority of the second window 2803, the first page 2802 is displayed in the PiP mode. As shown in \textcircled{1} of FIG. 27, the sizes of the first page 2802 are a width of w1 and a height of h1. If the television detects a change in the content of the first page 2802, such as a change to video page B, the television can determine to adjust the size of the first window 2801. Obtain the image sizes of the fourth page 2805, such as width w2 and height h2. The TV adjusts the size of the first window 2801 according to the image size of the fourth page and the size threshold of the PiP window, as shown in \textcircled{2} of FIG. 27. The adjusted width of the first window 2801 is w3 and the height is h3, w3/h3=w2/h2, and it can meet the size threshold of the PiP window. The fourth page 2805 is displayed within the adjusted first window 2801. The process of obtaining the image size of the fourth page 2805 and adjusting the first window 2801 according to the image size and the size threshold of the PiP window can be referred to in Embodiment 9, which will not be elaborated here.

When a display apparatus displays a PiP window, it can display a PiP menu within the PiP window. This PiP menu is a system menu and can include window control keys. Window control keys can be configured to control the display state of the PiP window. Window control keys can include move keys, full-screen keys, close keys, etc. Taking a television as an example, as shown in FIG. 28, when the television displays the PiP window 2902 on the full-screen window 2901, the PiP menu 2903 can be displayed within the PiP window 2902. PiP menu 2903 can include a move key 2904, a full-screen key 2905, and a close key 2906. Users can move the display position of the PiP window 2902 using the move key 2904; adjust the PiP window 2902 to full-screen state using the full-screen key 2905; and close the PiP window 2902 using the close key 2906 to exit PiP mode.

Since applications within a PiP window cannot receive focus, users cannot directly control applications within the PiP window. For example, when playing a video within a PiP window, since the PiP window cannot receive focus, the user cannot directly control the playback of the video based on the PiP window. Based on the system architecture shown in FIG. 5C, the display apparatus according to some embodiments of the present application can display a playback control menu in the PiP window, so that users can directly control the playback state of the video in the PiP window based on the playback control menu. In some embodiments, the display apparatus is not in the PiP mode. The display apparatus has created a first window and a second window, and the first page can be displayed in the first window and the second page can be displayed in the second window. The first window is in the full-screen state. The first window and the second window can be in the same layer, and the window priority of the first window can be higher than the window priority of the second window. Alternatively, the first window and the second window can be in different layers, and the priority of the layer to which the first window belongs can be at a higher level than the priority of the layer to which the second window belongs. The first page belongs to the first application. In some embodiments, the second window can also be in the full-screen state. Based on the system architecture shown in FIG. 5C, the display apparatus can display the PiP window according to the process shown in FIG. 29. The specific steps can include, but are not limited to, the following operations.

S2901, receive the first control command input by the user.

The first control command can be configured to indicate the activation of PiP mode. Step S2901 can be referred to steps S601 and S701-S702, which will not be repeated here. At this time, the first control command is the control command input by the user based on the designated entry point supported by the operating system. In other embodiments, the first control command can also be a control command input through an entry point provided by the application. It is understood that the present application does not limit the input method of the first control command.

S2902, in response to the first control command, shrink the size of the first window and display the second window. And display the first page in the first window after shrinking, and display the second page in the second window. When the first page is a video page, playback control keys are also displayed in the first window.

The process of the display apparatus entering the PiP mode can be referred to in steps S602, S801-S802, S1601-S1602, and S1701-S1702, which will not be repeated here.

The playback control keys can be configured to control the playback state of the video on the page within the PiP window. Playback control keys can include play, pause, fast forward, and rewind keys. Playback state can include playing, paused, fast forward, rewind, etc.

In this way, when playing a video within the PiP window, i.e. when the first page is a video page, playback control keys can be provided within the PiP window, allowing users to directly control the playback state of the video on the first page based on these playback control keys.

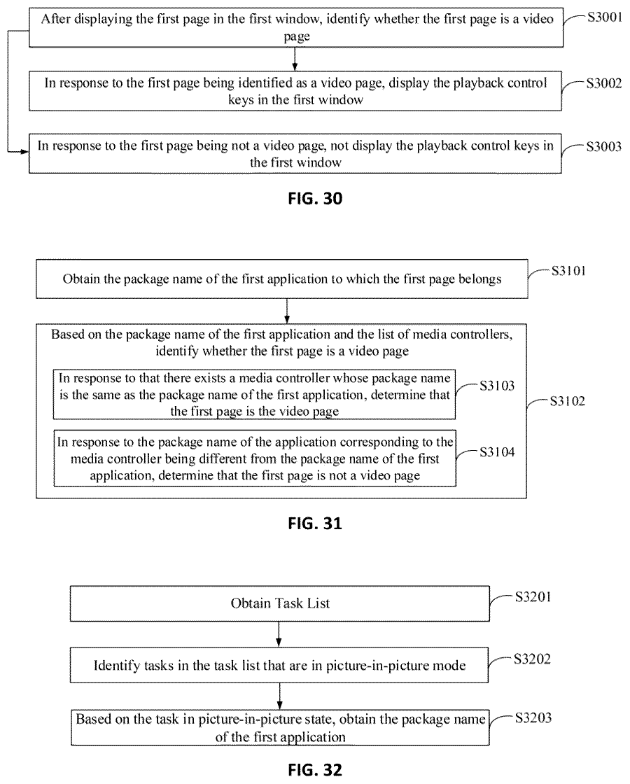

The display apparatus can display the playback control keys according to the process shown in FIG. 30. The specific steps can include, but are not limited to, the following operations.

S3001, after displaying the first page in the first window, identify whether the first page is a video page.

When the display apparatus actives the PiP mode, it first displays the first page in the shrunken first window, that is, the first page is displayed within the PiP window. Then, the display apparatus can determine whether to display playback control keys based on whether the first page is a video page.

The display apparatus can identify whether the first page is a video page according to the process shown in FIG. 31. The specific steps can include, but are not limited to, the following operations.

S3101, obtain the package name of the first application to which the first page belongs.

The display apparatus 200 can obtain the application of the top-level PiP window through ActivityManager, such as the first application in the first window.

The display apparatus can obtain the package name of the first application according to the process shown in FIG. 32. The specific steps can include, but are not limited to, the following operations.

S3201, obtain Task List.

The task list can include tasks that are currently running on the system.

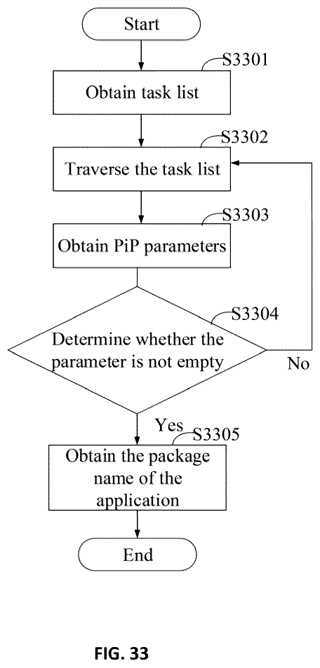

Based on the process shown in FIG. 33, the display apparatus needs to obtain the top-level window to obtain the first application. Based on the system architecture shown in FIG. 5C, the operating system provides an interface for ActivityManager to obtain the running tasks (RunningTaskInfo). However, since upper-layer applications can only obtain their own top-level windows, the application that the display apparatus obtains the top-level application is the system application, such as SystemUI. In this way, the display apparatus can obtain a task list that includes all application tasks (S3301).

S3202, identify tasks in the task list that are in picture-in-picture mode.

Tasks in PiP state are displayed in the first application within the first window.

Referring again to the process shown in FIG. 33, after obtaining the task list, the task currently in the PiP state is determined by traversing the task list (S3302). In some embodiments, the PiP parameter of the current task can be obtained through the getPictureInPictureParams interface of the parent class TaskInfo of RunningTaskInfo (S3303), and the task can be determined to be in PiP state based on whether the PiP parameter is empty (S3304). If the PiP parameter is not empty, then the task can be determined to be in the PiP state.

In some embodiments, if the obtained task list is empty, or there are no tasks in the PiP state in the task list, it means that no application is currently in PiP mode, that is, the display apparatus has not entered PiP mode.

S3203, based on the task in picture-in-picture state, obtain the package name of the first application.

The information about the top-level page can be obtained through mTopActivity of TaskInfo, such as ComponentName, and thus obtain the top-level window, such as the first window. Referring again to the process shown in FIG. 33, the package name of the application located in the top-level window can be obtained by calling the getPackageName method of this class (S3305), such as the package name of the first application, and then the application information of the first application can be obtained.

S3102, based on the package name of the first application and the list of media controllers, identify whether the first page is a video page.

When the PiP menu is accessed, the system displays the playback control menu based on whether a video is playing. After obtaining the package name of the first application, the system identifies whether the first page is a video page, i.e., whether a video is playing, based on the package name of the first application and the media controller list.

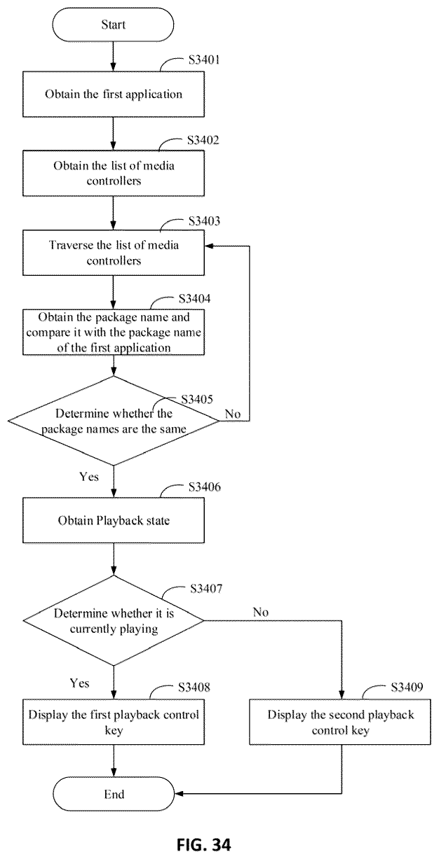

Referring to the flowchart shown in FIG. 34, the process of displaying the playback control menu on the display apparatus is explained.

Obtain the first application (S3401), and obtain the list of active media controllers through MediaSessionManager. The list of media controllers can include the media controllers playing videos (S3402). Iterate through the list of media controllers (S3403), call the getPackageName method of the media controller to obtain the package name of the corresponding application, and after obtaining the package name of the application corresponding to the media controller, compare the package name with the package name of the first application (S3404) to identify whether there is a package name that is the same as the package name of the first application (S3405).

S3103, in response to that there exists a media controller whose package name is the same as the package name of the first application, determine that the first page is the video page.

If there exists a media controller whose package name is the same as that of the first application, it means that the video played by that media controller is a video from the first application, and the first page is the video page.

S3104, in response to the package name of the application corresponding to the media controller being different from the package name of the first application, determine that the first page is not a video page.

If the package name of the application corresponding to each media controller is different from the package name of the first application, it means that the video played by each media controller does not belong to the first application, and therefore the first page is not a video page.

S3002, in response to the first page being identified as a video page, display the playback control keys in the first window.

If the first page is identified as a video page, then playback control can be performed on the video on that first page. At this time, the display apparatus shows playback control keys in the first window to provide users with an entry point for playback control.

S3003, in response to the first page being not a video page, not display the playback control keys in the first window.

If the first page is not a video page, it means there is no video base for playback control. At this time, the display apparatus does not show the playback control keys in the first window to avoid affecting the normal display of the first page and to avoid misleading the user in terms of operation.

In some embodiments, the display apparatus can display playback control keys and window control keys within the same PiP menu.

In some embodiments, the display apparatus can display playback control keys and window control keys in different PiP menus, which can be displayed simultaneously or not.

In some embodiments, the display apparatus can display playback control keys when entering the PiP mode, and/or the display apparatus can display playback control keys when the display apparatus detects that the focus is on the PiP window. Additionally, the display apparatus can hide the playback control keys when the display apparatus detects that the playback control keys have been displayed for a preset duration and the user has not interacted with the PiP window, and/or the display apparatus can hide the playback control keys when the display apparatus can detects that the focus has left the PiP window.

In some embodiments, the display apparatus displays playback control keys according to the playback state of the video in the PiP window, so that the displayed playback control keys match the playback state of the video, thereby providing the user with an effective playback control entry point.

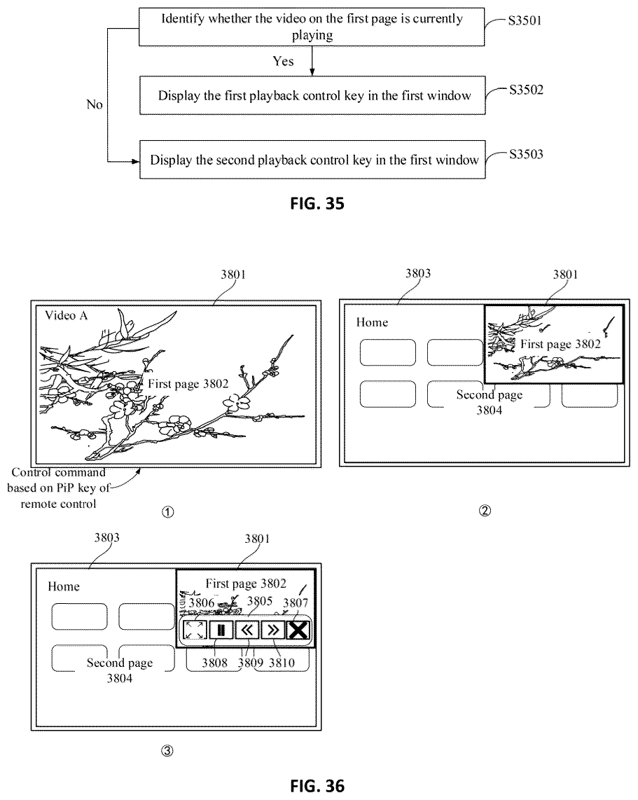

The display apparatus can display different playback control keys according to the process shown in FIG. 35. The specific steps can include, but are not limited to, the following operations.

S3501, identify whether the video on the first page is currently playing.

Following the process shown in FIG. 34, after determining that the media controller whose package name is the same as the package name of the first application, the getPlaybackState method of the media controller is called to obtain the playback state of the video within the media controller (S3406). Determine whether the playback state is in progress (S3407). When the playback state is STATE_PLAYING, it means that the video is in progress. When the playback state is STATE_PAUSED, it means that the playback is paused, not in progress. The playback control keys can include a first playback control key and a second playback control key. The first playback control key can be configured to control the playback state of a video that is currently playing. The first playback control key can include a pause key, a fast forward key, a rewind key, etc. The second playback control key can be configured to control the playback state of videos that are not currently playing. The second playback control key can include a play key, etc.

S3502, when the display apparatus detects that the video on the first page is in a playing state, display the first playback control key in the first window.

When the display apparatus detects that the video on the first page is in a playing state, the display apparatus displays the first playback control key (S3408) and does not display the second playback control key, so as to provide the user with a valid first playback control key, allowing the user to control the pause, fast forward or rewind of the video in play based on the first playback control key.

S3503, when the display apparatus detects that the video on the first page is not in a playing state, display a second playback control key in the first window.

When the display apparatus detects that the video on the first page is not playing, such as being paused, the display apparatus can show a second playback control key (S3409) and not show the first playback control key, so as to provide the user with a valid second playback control key, allowing the user to control the paused video to start playing based on the second playback control key.

Taking the display device 200 as an example of a television, combined with the following embodiments, explain the process of displaying PiP windows on the display device 200.

### Embodiment 11

As shown in \textcircled{1} of FIG. 36, the TV displays the first page 3802 in the first window 3801, such as video page A, and displays the second page 3804 (not shown in \textcircled{1} of FIG. 36) in the second window 3803, such as the Launcher page. Taking the example where both the first window 3801 and the second window 3803 are in the full-screen state, the first window 3801 and the second window 3803 are in the same layer, and the window priority of the first window 3801 is higher than the window priority of the second window 3803. In response to the first control command input by the user, the TV enters the PiP mode, as shown in \textcircled{2} of FIG. 36, shrinks the first window 3801, and exposes the second window 3803, which has a lower window priority. The first page 3802 is displayed in the first window 3801 after being shrunk, and the second page 3804 is displayed in the second window 3803. This process can be referred to the relevant content in Embodiments 1 to 10, and will not be repeated here. After the TV displays the first page 3802 in the shrunken first window 3801, it identifies whether the first page 3802 is a video page. In this embodiment, the television can determine that the first page 3802 is a video page. The TV further identifies the playback state of the video on the first page 3802, such as identifying that the video on the first page is in a playing state. As shown in \textcircled{3} of FIG. 36, the TV can display the PiP menu 3805 in the first window 3801, and display window control keys, such as the full screen key 3806 and the close key 3807, as well as the first playback control keys, such as the pause key 3808, the fast forward key 3809 and the rewind key 3810.

### Embodiment 12

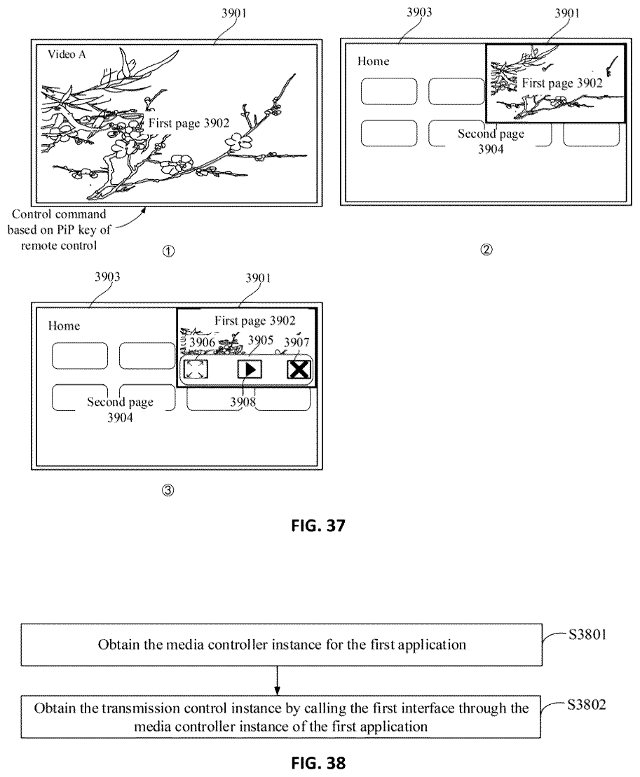

As shown in \textcircled{1} of FIG. 37, the TV displays the first page 3902 in the first window 3901, such as video page A, and displays the second page 3904 (not shown in \textcircled{1} of FIG. 37) in the second window 3903, such as the Launcher page. Taking the example where both the first window 3901 and the second window 3903 are in the full-screen state, the first window 3901 and the second window 3903 are in the same layer, and the window priority of the first window 3901 is higher than the window priority of the second window 3903. In response to the first control command of the user, the TV enters the PiP mode, as shown in \textcircled{2} of FIG. 37, shrinks the first window 3901, and exposes the second window 3903, which has a lower window priority. The first page 3902 is displayed in the first window 3901 after being shrunk, and the second page 3904 is displayed in the second window 3903. This process can be referenced from the relevant content in Embodiments 1 to 10, and will not be repeated here. After the television displays the first page 3902 in the shrunken first window 3901, the television can identify whether the first page 3902 is a video page. In this embodiment, the television can determine that the first page 3902 is a video page. The TV further identifies the playback state of the video on the first page 3902, such as the video is in a paused state. As shown in \textcircled{3} of FIG. 37, the TV can display the PiP menu 3905 in the first window 3901, and display window control keys, such as the full-screen key 3906 and the close key 3907, as well as the second playback control key, such as the play key 3908, in the PiP menu 3905.

After the display apparatus displays the playback control keys, the corresponding playback control implementation methods are configured for the playback control keys so that users can effectively control the playback state of the video in the PiP window based on these playback control keys.

The display apparatus can implement video playback control based on the playback control keys according to the process shown in FIG. 38. The specific steps can include, but are not limited to, the following operations.

S3801, obtain the media controller instance for the first application.

When obtaining the first application within the PiP window, the display apparatus can obtain the media controller instance of the first application.

S3802, obtain the transmission control instance by calling the first interface through the media controller instance of the first application.

The transport control instance (TransportControls) instance is assigned a value during the initialization of the media controller instance of the first application to provide a second interface for control keys. This second interface can be configured to call the session control instance to invoke the playback control operations of the media service through the session control instance.

The media controller instance can be obtained through the getTransportControlls interface. The transport control instance is assigned a value when the media controller instance object is initialized, and it can provide interfaces such as play, pause, video jump, fast forward, and rewind. Internally, it can call the session controller (IsessionController) to invoke the playback control operations of the media service.

In some embodiments, the display apparatus responds to a second control command input by the user based on a target playback control key, adjusting the playback state of the video to which the first page belongs to be the playback state corresponding to the target playback control key.

For example, when a user inputs a second control command based on the pause key, the display apparatus responds to the second control command by changing the playback state of the video on the first page from a playing state to a paused state. When the user inputs a second control command based on the play key, the display apparatus responds to the second control command and adjusts the playback state of the video on the first page from a paused state to a playing state.

In some embodiments, when the playback state of a video changes, the display apparatus can update the playback control keys displayed in the first window to provide the user with effective playback control keys.

When the playback state corresponding to the target playback control key is in a playing state, then the playback state of the video on the first page can be adjusted to a playing state, and the first playback control key can be hidden and the second playback control key can be displayed.

When the playback state corresponding to the target playback control key is in a paused state, the playback state of the video on the first page can be adjusted to the paused state, and the second playback control key can be hidden while the first playback control key is displayed.

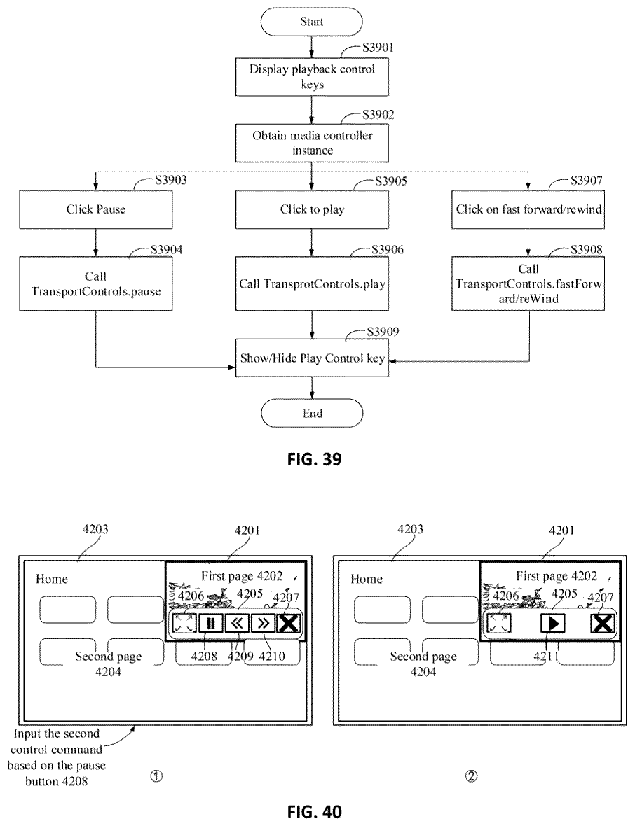

As shown in FIG. 39, the display apparatus can display the PiP menu in Wmshell, that is, display the playback control key (S3901), obtain the MediaController instance (S3902), and when the video is playing, and the user inputs a second control command based on the pause key, such as clicking the pause key (S3903), the MediaController is called. The TransportControls pause interface pauses the video playback (S3904) and displays the first playback control key, such as the pause key, fast forward key, rewind key, etc., and displays the second playback control key, such as the play key, etc. (S3909). When the video is playing, and the user inputs a second control command based on the fast forward key, such as clicking the fast forward key (S3907), the fastForward interface of TransportControls is called to fast forward the video (S3908). When the video finishes playing, the skipToNext interface of TransportControls is called to jump to play the next video. When a video is playing, and the user inputs a second control command based on the rewind key, such as clicking the rewind key (S3907), the reWind interface of TransportControls is called to rewind the video (S3908). When the video is rewound to the beginning, TransportControls skipToPrevious is called to jump to play the previous video. When the video is in the paused state, and the user inputs a second control command based on the play key, such as clicking the play key (S3905), the play interface of TransportControls is called to play the video (S3906), and the second playback control key, such as the play key, is hidden, while the first playback control key, such as the pause key, fast forward key, rewind key, etc., is displayed (S3909).

Taking display device 200 as an example of a television, the process of updating playback control keys on display device 200 will be explained with the following embodiments.

### Embodiment 13

The television can respond to the first control command and enter PiP mode in accordance with the process shown in Embodiment 11, as shown in \textcircled{1} of FIG. 40. The television can display the first page 4202 in the first window 4201, such as video page A, and display the second page 4204 in the second window 4203, such as the Launcher page. The television also displays a PiP menu 4205 in the first window 4201, and displays window control keys such as a full-screen key 4206 and a close key 4207, as well as first playback control keys such as a pause key 4208, a fast forward key 4209, and a rewind key 4210 in the PiP menu 4205. When the user inputs a second control command based on the pause key 4208, the TV can respond to the second control command by pausing video playback, and as shown in \textcircled{2} of FIG. 40, hide the pause key 4208, fast forward key 4209 and rewind key 4210, and display the play key 4211.

In some embodiments, when the page in the first window changes, the display apparatus can update the playback control keys displayed in the first window to provide the user with valid playback control keys.

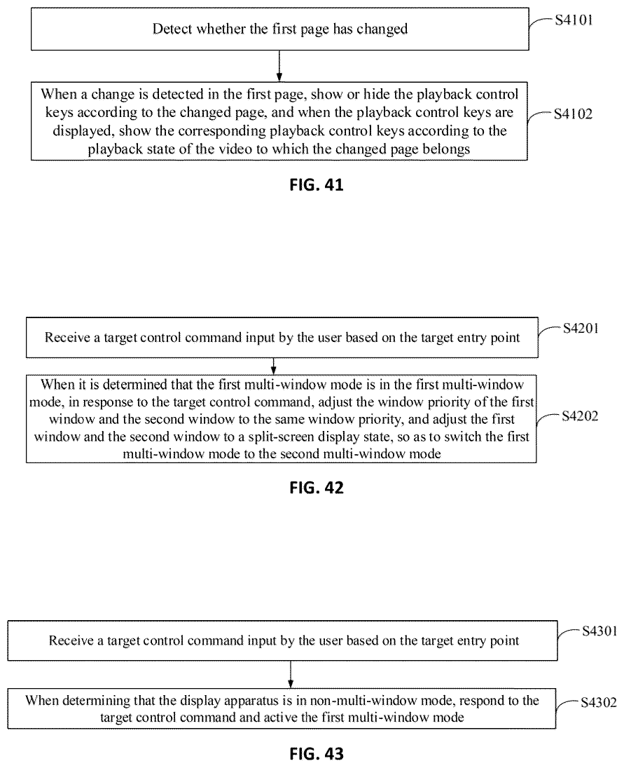

The display apparatus can update the playback control keys according to the process shown in FIG. 41. The specific steps can include, but are not limited to, the following operations.

S4101, detect whether the first page has changed.

Changes to the first page can include changing from a video page to a non-video page, or changing from a non-video page to a video page.

S4102, when a change is detected in the first page, show or hide the playback control keys according to the changed page, and when the playback control keys are displayed, show the corresponding playback control keys according to the playback state of the video to which the changed page belongs.

When the display apparatus detects a change in the first page, it can re-determine whether to display the playback control keys based on the changed page, and when determining to display the playback control keys, it can determine which playback control keys to display.

In some embodiments, when the first page is a video page, and the display apparatus detects that the first page has changed to a non-video page, then the display apparatus cannot display the playback control keys in the first window.

In some embodiments, when the first page is not a video page, but the display apparatus detects that the first page has changed to a video page, then the display apparatus can display playback control keys in the first window. When the display apparatus detects that the video to which the changed page belongs is in a playing state, a first playback control key is displayed in the first window; when the display apparatus detects that the video to which the changed page belongs is in a paused state, a second playback control key is displayed in the first window.

Display apparatus can be configured with various multi-window modes, such as PiP mode and Split Screen mode. In related art, since the various multi-window modes cannot be switched directly, if a user wants to switch from the current multi-window mode to another multi-window mode, they need to first exit the current multi-window mode and then open the other multi-window mode based on the entry point of the other multi-window mode. It is evident that the process of switching between multiple window modes is rather cumbersome. Based on the system architecture shown in FIG. 5D, the display apparatus according to some embodiments of the present application can provide a unified entry point, allowing users to input target control commands based on this unified entry point, activating the display apparatus to directly switch between different multi-window modes, thereby simplifying the switching process between multi-window modes. In some embodiments, the display apparatus is in a first multi-window mode. In the first multi-window mode, the display apparatus can display a first window and a second window, and the first page can be displayed in the first window and the second page can be displayed in the second window. The second window can be in the full-screen state, and the size of the first window can be smaller than the size of the second window. The first window and the second window can be in the same layer, and the window priority of the first window can be higher than the window priority of the second window, that is, the display apparatus is in the PiP mode. Based on the system architecture shown in FIG. 5D, the display apparatus can switch to multi-window mode according to the process shown in FIG. 42. The specific steps can include, but are not limited to, the following operations.

S4201, receive a target control command input by the user based on the target entry point.

The target entry point is a designated entry point supported by the operating system. Target entry points can include multi-window keys on control devices (such as the Global Multi-Screen key), multi-window keys on the virtual keyboard of display apparatus (such as the Split-Screen Global key), and entry points in the system menu. The multi-window key corresponds to a key value, which is configured to active or switch between multi-window modes. In some embodiments, the system menu can be a shortcut menu, and the target entry point can be the multi-window mode option in the shortcut menu. This target entry point is independent of the application itself and is not affected by the application itself. Therefore, this target entry point can serve as a unified entry point for activating and switching between multi-window modes across various applications.

Define a global multi-screen key in the system PhoneWindowManager. The global multi-screen key can be any special key and can correspond to any key value. This global multi-screen key can be configured to trigger multi-window services. This multi-window service can be a customized service or a functional module used to trigger switching between multi-window modes.

Before activating the first multi-window mode, the display apparatus is in non-multi-window mode. In non-multi-window mode, the display apparatus has created a first window and a second window, and the first page can be displayed in the first window and the second page can be displayed in the second window. Both the first window and second window are in the full-screen state. The first window and second window can be in the same layer, and the window priority of the first window can be higher than the window priority of the second window. The display apparatus can enter the first multi-window mode according to the process shown in FIG. 43. The specific steps can include, but are not limited to, the following operations.

S4301, receive a target control command input by the user based on the target entry point.

S4302, when determining that the display apparatus is in non-multi-window mode, respond to the target control command and active the first multi-window mode.

After receiving the target control command, the display apparatus first identifies whether the display apparatus is currently in multi-window mode. If the display apparatus determines that the display apparatus is not in multi-window mode (i.e., not in multi-window mode), then the target control command indicates that multi-window mode should be activated. If the display apparatus is determined to be in multi-window mode, then the target control command can be determined to indicate that the multi-window mode should be switched.

In some embodiments, the multi-screen service can be configured to have an activation priority for multiple window modes, such as prioritizing the activation of the first multi-window mode when not in multi-window mode. When the multi-screen service determines that the current working state is not in multi-window mode, it can reset the state to be switched to the first multi-window mode according to the activation priority of multi-window mode. The multi-screen service uses information about the first application and second application that support multi-window mode in the Activity stack, obtained from the application manager. The first application can be an application within the first window, and the second application can be an application within the second window. The multi-screen service can trigger handlePictureInPicture in MultiWindowManager by obtaining the information, and enter the first multi-window mode.

The process of activating the first multi-window mode on the display apparatus can be referred to in steps S602, S1601-S1602, S2902 and related content, which will not be elaborated here.

S4202, when it is determined that the first multi-window mode is in the first multi-window mode, in response to the target control command, adjust the window priority of the first window and the second window to the same window priority, and adjust the first window and the second window to a split-screen display state, so as to switch the first multi-window mode to the second multi-window mode.

When the display apparatus determines that it is in the first multi-window mode, it can determine the target control command to switch the multi-window mode, that is, switch the first multi-window mode to the second multi-window mode. The second multi-window mode is the split-screen mode.

The multi-screen service reset requires switching to the second multi-window mode. Based on the system architecture shown in FIG. 5D, the multi-screen service obtains information about the first and second applications that support multi-window mode in the Activity stack from the application manager. The first application is the application within the first window, and the second application is the application within the second window. The multi-screen service uses the information it obtained to trigger handleSplitScreen in MultiWindowManager, thus entering the second multi-window mode.

The display apparatus can display the first window and second window in a split-screen state by enlarging the size of the first window, shrinking the size of the second window, and adjusting the display positions of the first window and second window. The split-screen display state of the first window and the second window can include landscape split-screen or portrait split-screen. The display apparatus can also adjust the window priority of the first window and the second window to the same window priority to ensure that the first window and the second window can be displayed simultaneously in the same layer.

After the display apparatus switches to the second multi-window mode, the first page can be displayed in the first window and the second page can be displayed in the second window. That is, during the process of switching between the first multi-window mode and the second multi-window mode, the first application and the second application can remain in multi-window mode.

In the first multi-window mode, the application in the first window cannot receive focus on the display apparatus. Therefore, users cannot directly control the applications in the first window, that is, they cannot directly control the applications within the PiP window. However, in the second multi-window mode, applications in both the first window and second window can obtain focus on the display apparatus. Based on this, users can switch from the first multi-window mode to the second multi-window mode, allowing applications in both the first window and second window to obtain focus, thereby controlling the applications in the first window and second window.

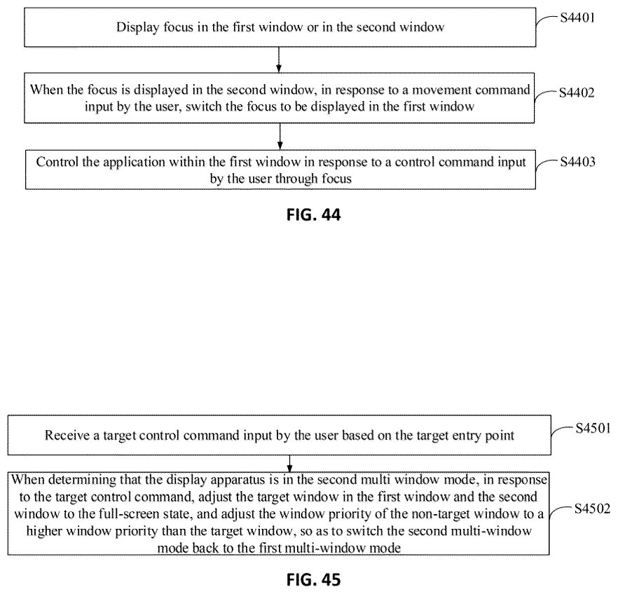

After switching the display apparatus from the first multi-window mode to the second multi-window mode, the application in the first window can be controlled according to the process shown in FIG. 44. The specific steps can include, but are not limited to, the following operations.

S4401, display focus in the first window or in the second window.

After the display apparatus switches to the second multi-window mode, applications in both the first window and second window can obtain focus. The display apparatus can display the focus in the first window or second window according to preset rules. Preset rules can include: prioritizing displaying focus in the second window, or prioritizing displaying focus in the first window.

S4402, when the focus is displayed in the second window, in response to a movement command input by the user, switch the focus to be displayed in the first window.

If the display apparatus prioritizes displaying focus in the second window, the user can input a movement command to the display apparatus to instruct the focus to be switched to the first window. For example, users can long-press the global multi-screen key and enter a movement command to trigger FocusManager to switch the window focus.

S4403, control the application within the first window in response to a control command input by the user through focus.

In the second multi-window mode, when the focus is displayed in the first window, the user can control the application based on the focus.

In some embodiments, the display apparatus can switch back from the second multi-window mode to the first multi-window mode according to the process shown in FIG. 45. The specific steps can include, but are not limited to, the following operations.

S4501, receive a target control command input by the user based on the target entry point.

Step S4501 can be referred to step S4201, and will not be repeated here.

S4502, when determining that the display apparatus is in the second multi window mode, in response to the target control command, adjust the target window in the first window and the second window to the full-screen state, and adjust the window priority of the non-target window to a higher window priority than the target window, so as to switch the second multi-window mode back to the first multi-window mode.

When the display apparatus determines that it is in the second multi-window mode, it can determine that the target control command indicates to switch the multi-window mode, that is, to switch the second multi-window mode to the first multi-window mode.

When the display apparatus enters the first multi-window mode, it can determine the target window. The target window can be the system default window in the first window and second window, the window located at a specified position, the window currently having focus, or the window not currently having focus, etc.

The multi-screen service is reset to the state that needs to be switched, that is, the first multi-window mode. Based on the system architecture shown in FIG. 5D, the multi-screen service obtains information about the first application and second application that support multi-window mode in the Activity stack from the application manager. The first application is the application within the first window, and the second application is the application within the second window. The multi-screen service uses the information it obtained to trigger handlePictureInPicture in MultiWindowManager, thus entering the first multi-window mode.

After the display apparatus switches back to the first multi-window mode, the first page can be displayed in the first window and the second page can be displayed in the second window. That is, during the process of switching between the second multi-window mode and the first multi-window mode, the first application and the second application can remain in multi-window mode.

Based on the above process of entering multi-window mode and switching between different multi-window modes, it can be seen that users can instruct the display apparatus to enter multi-window mode and switch directly between different multi-window modes based on the same target entry point. The user operation is simple and fast, and the multi-window mode switching efficiency of the display apparatus is high.

Taking the display apparatus 200 as a television and the control device 100 as a remote control, with the remote control having a target entry point, such as a global multi-screen key, as an example, the process of the display apparatus 200 switching to multi-window mode is explained.

### Embodiment 14

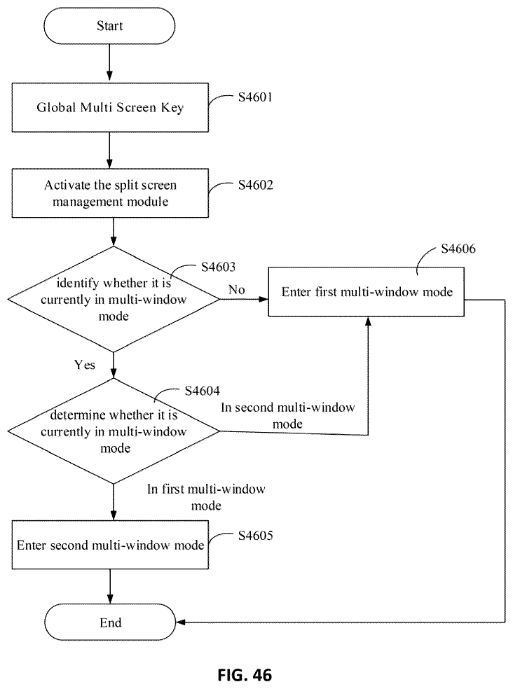

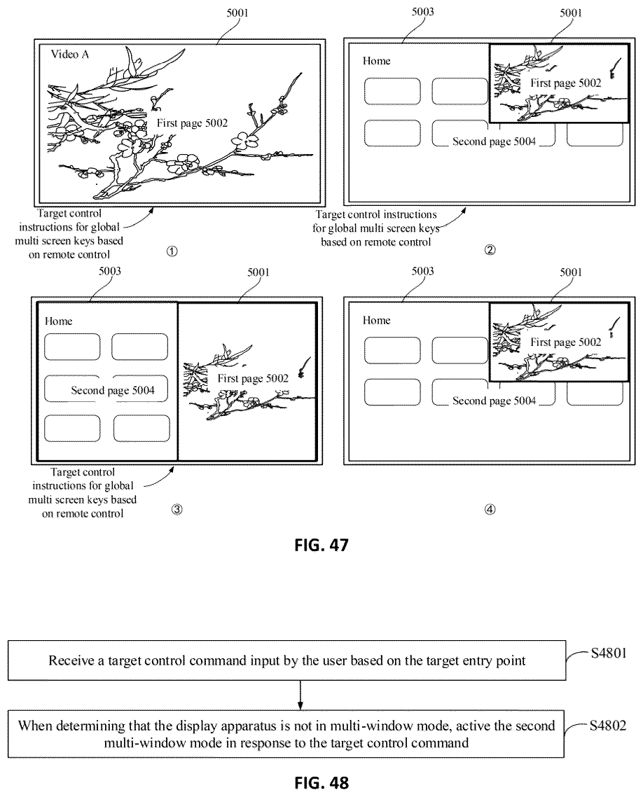

Referring to the process shown in FIG. 46, as shown in \textcircled{1} of FIG. 47, the TV displays the first page 5002 in the first window 5001, such as video page A, and displays the second page 5004 (not shown in \textcircled{1} of FIG. 47) in the second window 5003, such as the Launcher page. Taking the example where both the first window 5001 and the second window 5003 are in the full-screen state, the first window 5001 and the second window 5003 are in the same layer, and the window priority of the first window 5001 is higher than the window priority of the second window 5003. Users can input target control commands to the TV using the global multi-screen key on the remote control (S4601). The TV then activates the split-screen management module (S4602) and identifies whether it is currently in multi-window mode (S4603). If it is identified that it is not currently in multi-window mode, the target control command is determined to enter multi-window mode. If the TV is configured to prioritize activating the first multi-window mode, as shown in \textcircled{2} of FIG. 47, the TV shrinks the first window 5001 and exposes the second window 5003 with a lower window priority. The first page 5002 is displayed in the shrunken first window 5001, and the second page 5004 is displayed in the second window 5003 in the full-screen state, so as to enter the first multi-window mode, namely PiP mode (S4604). At this time, the application in the second window 5003 can obtain focus, while the application in the first window 5001 cannot obtain focus. Users can input target control commands to the TV using the global multi-screen key on the remote control. The TV identifies that it is currently in the first multi-window mode and determines that the target control command instructs to switch the multi-window mode, that is, to switch the first multi-window mode to the second multi-window mode (S4605). As shown in \textcircled{3} of FIG. 47, the TV can adjust the window priority of the first window 5001 and the second window 5003 to the same level, and can adjust the first window 5001 and the second window 5003 to a split-screen display state, such as a left-right split-screen display state. The television can display the first page 5002 in the first window 5001 and the second page 5004 in the second window 5003, so that it can switch from the first multi-window mode to the second multi-window mode, i.e., split-screen mode. At this point, both applications within the first window 5001 and the second window 5003 can obtain focus. If the application in the second window 5003 obtains focus first, the user can input a movement command to the TV through the remote control to instruct the TV to switch the focus to the first window 5001. At this time, the user can control the application in the first window 5001 based on the focus. Users can input target control commands to the TV using the global multi-screen key on the remote control. The TV identifies that it is currently in the second multi-window mode and determines that the target control command instructs to switch the multi-window mode, that is, the second multi-window mode can be switched to the first multi-window mode (S4606). The television determines the target window. For example, the television determines the target window based on the window where the focus is located. Taking the second window 5003 as an example, the television can determine the second window 5003 as the target window. As shown in \textcircled{4} of FIG. 47, the TV can adjust the second window 5003 to the full-screen state and adjust the window priority of the first window 5001 to be higher than the window priority of the second window 5003. The television displays the first page 5002 in a smaller first window 5001 and the second page 5004 in a full-screen second window 5003, in order to switch back from the second multi-window mode to the first multi-window mode.

In some embodiments, the display apparatus is in a first multi-window mode. In the first multi-window mode, the display apparatus can display a first window and a second window, and the first page can be displayed in the first window and the second page can be displayed in the second window. The second window is in the full-screen state, and the size of the first window can be smaller than the size of the second window. The first window and the second window can be in different layers, and the priority of the layer to which the first window belongs can be at a higher level than the priority of the layer to which the second window belongs, meaning the display apparatus is in the PiP mode. Based on the system architecture shown in FIG. 5D, the display apparatus can switch from the first multi-window mode to the second multi-window mode by referring to steps S4201-S4202. The display apparatus can adjust the size of the first window and the second window to display them side by side, without adjusting the priorities of the layers to which the first window and the second window belong.

In some embodiments, the display apparatus is in a second multi-window mode. The display apparatus can display a first window and a second window, and can display a first page in the first window and a second page in the second window. The first window and second window can be displayed side by side. The first window and second window can be in the same layer, and the window priorities of the first window and second window can be the same, that is, the display apparatus is in the split-screen mode. Based on the system architecture shown in FIG. 5D, the display apparatus can switch from the second multi-window mode to the first multi-window mode according to the process shown in FIG. 45, which will not be elaborated here.

The display apparatus is in the non-multi-window mode before activating the second multi-window mode. In the non-multi-window mode, the display apparatus has created a first window and a second window, and the first page can be displayed in the first window and the second page can be displayed in the second window. Both the first window and second window are in the full-screen state. The first window and second window can be in different layers, and the priority of the layer to which the first window belongs can be at a higher level than the priority of the layer to which the second window belongs. The display apparatus can enter the second multi-window mode according to the process shown in FIG. 48. The specific steps can include, but are not limited to, the following operations.

S4801, receive a target control command input by the user based on the target entry point.

S4802, when determining that the display apparatus is not in multi-window mode, active the second multi-window mode in response to the target control command.

In some embodiments, the multi-screen service can be configured to have the activation priorities for multiple window modes, such as prioritizing the activation of a second multi-window mode when not in multi-window mode. Therefore, when the multi-screen service determines that it is not in multi-window mode, it can prioritize entering the second multi-window mode. In the second multi-window mode, the display apparatus can control the applications in each window according to steps S4401-S4402.

When the display apparatus switches from the second multi-window mode to the first multi-window mode, the target window can be determined first. At this time, the target window can be the main window in the first multi-window mode. The target window can be the window currently in focus in the first window or the second window, a window that is not in focus, or a window located at a specified position.

In some embodiments, the display apparatus can switch back from a first multi-window mode to a second multi-window mode according to the process shown in FIG. 42, which will not be described in detail here.

Taking the display apparatus 200 as a television and the control device 100 as a remote control, with the remote control having a target entry point, such as a global multi-screen key, as an example, the process of the display apparatus 200 switching to multi-window mode is explained.

### Embodiment 15

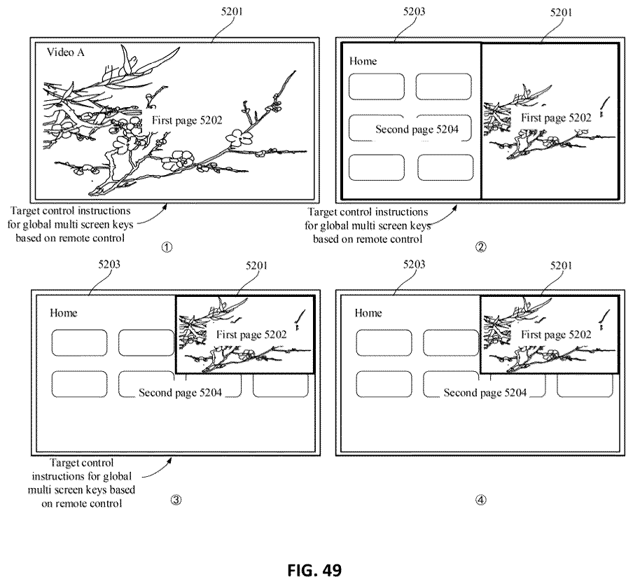

As shown in \textcircled{1} of FIG. 49, the television can display the first page 5202 in the first window 5201, such as video page A, and display the second page 5204 (not shown in \textcircled{1} of FIG. 49), such as the Launcher page, in the second window 5203. Taking the example where both the first window 5201 and the second window 5203 are in the full-screen state, the first window 5201 and the second window 5203 are in the same layer, and the window priority of the first window 5201 is higher than the window priority of the second window 5203. Users can input the target control command to the TV using the global multi-screen key on the remote control. The TV can identify that it is not currently in multi-window mode and determine that the target control command can indicate the TV to enter multi-window mode. If the TV is configured to prioritize activating the second multi-window mode, as shown in \textcircled{2} of FIG. 49, the TV can adjust the window priorities of the first window 5201 and the second window 5203 to the same level and display the first window 5201 and the second window 5203 in a split-screen format. The first page 5202 is displayed in the first window 5201, and the second page 5204 is displayed in the second window 5203, so as to enter the second multi-window mode, i.e. split-screen mode. At this point, both applications within the first window 5201 and the second window 5203 can obtain focus. Users can input a movement command to the TV through the remote control to indicate the TV to switch the display focus between the first window 5201 and the second window 5203. Users can then control the applications within the window where the focus is located based on this focus. Users can input the target control commands to the TV using the global multi-screen key on the remote control. The TV can identify that it is currently in the second multi-window mode and determine that the target control command indicates the user to switch to the first multi-window mode. The television can determine the target window. For example, the television can determine the target window based on the window where the focus is located. Taking the second window 5203 as an example, the television can determine the second window 5203 as the target window.

As shown in \textcircled{3} of FIG. 49, the TV can adjust the second window 5203 to the full-screen state and adjust the window priority of the first window 5201 to be higher than the window priority of the second window 5203. The television can display the first page 5202 in a smaller first window 5201 and the second page 5204 in the full-screen second window 5203, in order to switch from the second multi-window mode to the first multi-window mode, namely PiP mode. At this time, the application in the second window 5203 can obtain focus, while the application in the first window 5201 cannot obtain focus. Users can input target control commands to the TV using the global multi-screen key on the remote control. The TV can identify that it is currently in the first multi-window mode and determine that the target control command indicates the user to switch to the second multi-window mode. As shown in \textcircled{4} of FIG. 49, the TV can readjust the window priority of the first window 5201 and the second window 5203 to the same level, and adjust the first window 5201 and the second window 5203 to a split-screen display state, such as a left-right split-screen display state. The television can display the first page 5202 in the first window 5201 and the second page 5204 in the second window 5203, so as to switch the first multi-window mode back to the second multi-window mode.

In some embodiments, the display apparatus is in a second multi-window mode. In the second multi-window mode, the display apparatus can display the first window and the second window side by side, and the first page can be displayed in the first window and the second page can be displayed in the second window. The first window and the second window can be in different layers, and the priority of the layer to which the first window belongs can be at a higher level than the priority of the layer to which the second window belongs, meaning the display apparatus is in split-screen mode. Based on the system architecture shown in FIG. 5D, the display apparatus can switch from the second multi-window mode to the first multi-window mode by referring to steps S4501-S4502. The display apparatus can adjust the priority of the layer to which the target window belongs to be higher than the priority of the layer to which the non-target window belongs. For example, when the target window is the first window, the display apparatus does not need to adjust the priorities of the layers to which the first window and second window belong. When the target window is the second window, the display apparatus needs to adjust the priority of the layer to which the second window belongs to be higher than the priority of the layer to which the first window belongs.

For the convenience of explanation, the above description has been made in conjunction with specific embodiments. However, the above discussion in some embodiments is not intended to be exhaustive or limit the embodiments to the specific forms disclosed above. According to the above teachings, various modifications and variations can be obtained. The selection and description of the above embodiments are intended to better explain the content of this disclosure, so that those skilled in the art can better use the embodiments.

What is claimed is:

1. A display apparatus, comprising:
a display, configured to display a first page in a first window and a second page in a second window; wherein the first window and the second window are in a same layer, a window priority of the first window is higher than a window priority of the second window, and the first window is in a full-screen state;
a memory, configured to store computer instructions and/or data associated with the display apparatus;
at least one processor, connected to the display and the memory, and configured to execute the computer instructions to cause the display apparatus to perform:
receiving a control command input by a user based on a designated entry point supported by an operating system, wherein the control command is configured to indicate an activation of a picture-in-picture mode;
in response to the control command, based on that the first page supports the picture-in-picture mode, controlling the display to shrink a size of the first window and display the second window, wherein the first page is displayed in a shrunken first window and the second page is displayed in the second window.

2. The display apparatus according to claim 1, wherein the designated entry point comprises at least one of: a first key on a control device of the display apparatus, a second key on a virtual keyboard displayed on the display, or a first entry point in a system menu;
the memory is configured to store a first key value corresponding to the first key and a second key value corresponding to the second key, wherein the first key value and the second key value correspond to the activation of the picture-in-picture mode;
in response to the control command comprising a key value, the at least one processor is further configured to execute the computer instructions to cause the display apparatus to perform:
determining whether the control command comprises the first key value or the second key value;
based on determining that the control command comprises the first key value or the second key value, in response to the control command, activating the picture-in-picture mode based on that the first page supports the picture-in-picture mode.

3. The display apparatus according to claim 1, wherein the at least one processor is further configured to execute the computer instructions to cause the display apparatus to perform:
in response to the control command, determining the first page according to a focus;
determining whether the first page supports the picture-in-picture mode.

4. The display apparatus according to claim 1, wherein, based on that the first page does not support the picture-in-picture mode, the picture-in-picture mode is not activated, and the at least one processor is further configured to execute the computer instructions to cause the display apparatus to perform:
controlling the display to display a prompt message, wherein the prompt message is configured to indicate that the first page does not support the picture-in-picture mode.

5. The display apparatus according to claim 1, wherein the at least one processor is further configured to execute the computer instructions to cause the display apparatus to perform:
receiving a first control command input by the user, wherein the first control command is configured to indicate the activation of the picture-in-picture mode;
in response to the first control command, controlling the display to shrink the size of the first window and display the second window;
displaying the first page in the shrunken first window and displaying the second page in the second window;
based on that the first page is a video page, controlling the display to display a playback control key in the first window; wherein the playback control key is configured to control a playback state of a video on the first page.

6. The display apparatus according to claim 5, wherein the at least one processor is further configured to execute the computer instructions to cause the display apparatus to perform:
after displaying the first page in the first window, determining whether the first page is the video page;
in response to the first page being the video page, controlling the display to display the playback control key in the first window;
in response to the first page not being the video page, controlling the display not to display the playback control key in the first window.

7. The display apparatus according to claim 6, wherein the at least one processor is further configured to execute the computer instructions to cause the display apparatus to perform:
obtaining a package name of a first application to which the first page belongs;
determining whether the first page is the video page according to the package name of the first application and a list of media controllers, wherein the list of media controllers comprises a plurality of media controllers that play videos;
in response to the list of media controllers comprising a media controller whose application package name is same as the package name of the first application, determining that the first page is the video page;
in response to the list of media controllers not comprising a media controller whose application package name is same as the package name of the first application, determining that the first page is not the video page.

8. The display apparatus according to claim 7, wherein the at least one processor is further configured to execute the computer instructions to cause the display apparatus to perform:
obtaining a task list, wherein the task list comprises tasks currently running on a system;
identifying a task in the task list that is in the picture-in-picture mode, wherein the task in the picture-in-picture mode corresponds to the first application displayed in the first window;
obtaining the package name of the first application according to the task in the picture-in-picture state.

9. The display apparatus according to claim 8, wherein the at least one processor is further configured to execute the computer instructions to cause the display apparatus to perform:
obtaining a media controller instance of the first application;
obtaining a transmission control instance by calling a first interface through media controller instance of the first application;
wherein the transmission control instance is assigned a value when the media controller instance of the first application is initialized to provide a second interface for a control key; and
the second interface is configured to call a session control instance to call a playback control operation of a media service through the session control instance.

10. The display apparatus according to claim 5, wherein the at least one processor is further configured to execute the computer instructions to cause the display apparatus to perform:
determining whether the video on the first page is in a playing state;
in response to the video on the first page being in the playing state, controlling the display to display a first playback control key in the first window; wherein the first playback control key is configured to control the playback state of the video in the playing state;
in response to the video on the first page being not in the playing state, controlling the display to display a second playback control key in the first window; wherein the second playback control key is configured to control the playback state of the video that is not in the playing state.

11. The display apparatus according to claim 10, wherein the at least one processor is further configured to execute the computer instructions to cause the display apparatus to perform:
in response to a second control command input by the user based on a target playback control key, adjusting the playback state of the video on the first page to a playback state corresponding to the target playback control key.

12. The display apparatus according to claim 11, wherein the at least one processor is further configured to execute the computer instructions to cause the display apparatus to perform:
based on that the playback state corresponding to the target playback control key is in the playback state, adjusting the playback state of the video on the first page to the playing state, and controlling the display to hide the second playback control key and display the first playback control key;
based on that the playback state corresponding to the target playback control key is a pause playback state, adjusting the playback state of the video on the first page to the pause playback state, and controlling the display to hide the first playback control key and display the second playback control key.

13. The display apparatus according to claim 5, wherein the at least one processor is further configured to execute the computer instructions to cause the display apparatus to perform:
detecting whether the first page has changed;
in response to a change being detected in the first page, controlling the display to display or hide the playback control key according to a changed page;
based on controlling the display to display the playback control key, displaying a corresponding playback control key according to the playback state of the video on the changed page;
wherein the change in the first page comprises: the first page changes from a video page to a non-video page, or the first page changes from a non-video page to a video page.

14. The display apparatus according to claim 1, wherein the at least one processor is further configured to execute the computer instructions to cause the display apparatus to perform:
in response to a first control command input by the user, obtaining an image size of the first page;
controlling the display to: shrink the first window according to the image size and a size threshold of a picture-in-picture window, and display the second window;
wherein an aspect ratio of the shrunken first window is equal to an aspect ratio of the first page; the first page is displayed in the shrunken first window, and the second page is displayed in the second window.

15. The display apparatus according to claim 14, wherein the at least one processor is further configured to execute the computer instructions to cause the display apparatus to perform:
determining a display parameter of the first window according to the image size and the size threshold of the picture-in-picture window; wherein the display parameter comprises a size of the first window and a display position of the first window, the size of the first window satisfies the size threshold of the picture-in-picture window, and an aspect ratio of the first window is equal to the aspect ratio of the first page;
determining a display size of the first page according to the size of the first window;
displaying the shrunken first window according to the display parameter, and displaying the first page in the shrunken first window according to the display size.

16. The display apparatus according to claim 14, wherein the at least one processor is further configured to execute the computer instructions to cause the display apparatus to perform:
in response to an image size of the first page in the picture-in-picture mode being not obtained, controlling the display to shrink the size of the first window to a preset size.

17. The display apparatus according to claim 14, wherein the at least one processor is further configured to execute the computer instructions to cause the display apparatus to perform:
detecting whether the first page has changed;
in response to a change being detected in the first page, controlling the display to adjust the size of the first window according to a changed page; wherein an aspect ratio of an adjusted first window is equal to an aspect ratio of the changed page.

18. The display apparatus according to claim 17, wherein the at least one processor is further configured to execute the computer instructions to cause the display apparatus to perform:
in response to detecting that the first page changes from a first screen display orientation to a second screen display orientation, obtaining an image size of a third page; wherein the third page is obtained by changing the first page from the first screen display orientation to the second screen display orientation;
adjusting the size of the first window to obtain an adjusted first window according to the image size of the third page and the size threshold of the picture-in-picture window; wherein an aspect ratio of the adjusted first window is equal to an aspect ratio of the third page;
or,
wherein the at least one processor is further configured to execute the computer instructions to cause the display apparatus to perform:
in response to detecting that a content of the first page changes from a first image content to a second image content, obtaining an image size of a fourth page, wherein the fourth page is a page containing the second image content;
adjusting the size of the first window to obtain an adjusted first window according to the image size of the fourth page and the size threshold of the picture-in-picture window; wherein an aspect ratio of the adjusted first window is equal to an aspect ratio of the fourth page.

19. The display apparatus of claim 14, wherein the at least one processor is further configured to execute the computer instructions to cause the display apparatus to perform:
in response to a second control command input by the user, obtaining an image size of the second page;
controlling the display to adjust the shrunken first window to be in the full-screen state;
shrinking the second window according to the image size of the second page and the size threshold of the picture-in-picture window; and
adjusting the window priority of the second window to be higher than the window priority of the first window;
wherein the first page is displayed in the first window in the full-screen state, and the second page is displayed in a shrunken second window.

20. A window processing method for a display apparatus, wherein the display apparatus displays a first page in a first window and a second page in a second window, the first window and the second window are in a same layer, a window priority of the first window is higher than a window priority of the second window, and the first window is in a full-screen state;
wherein the method comprises:
receiving a control command input by a user based on a designated entry point supported by an operating system, wherein the control command is configured to indicate an activation of a picture-in-picture mode;
in response to the control command, based on that the first page supports the picture-in-picture mode, shrinking a size of the first window and displaying the second window, wherein the first page is displayed in a shrunken first window and the second page is displayed in the second window.
